(19) United States
(12) Patent Application Publication
(10) Pub. No.: US 2004/0015830 A1
(43) Pub. Date: Jan. 22, 2004

(54) Computational divided differencing

(76) Inventor: Thomas W. Reps, Madison, WI (US)

Correspondence Address: QUARLES & BRADY LLP, 411 E. WISCONSIN AVENUE, SUITE 2040, MILWAUKEE, WI, 53202-4497, US

(21) Appl. No.: 10/161,461

(22) Filed: May 31, 2002

Related U.S. Application Data
(60) Provisional application No. 60/294,904, filed on May 31, 2001.

(51) Int. Cl. G06F 9/44

(52) U.S. Cl. 717/104

(57) ABSTRACT

This invention concerns the manipulation and restructuring of programs that compute numerical functions using floating-point numbers, for the purpose of controlling round-off error. In particular, it provides a variety of means for transforming a program that computes a numerical function F(x) into a related program that computes divided differences of F:

One such transformation creates a program that computes F[x₀, x₁], the first divided difference of F(x), where

$$F [ {x}_{0} , {x}_{1} ] {=}^{def} \{ \begin{matrix}\frac{F ( {x}_{0} ) - F ( {x}_{1} )}{{x}_{0} - {x}_{1}} & if {x}_{0} \neq {x}_{1} \\ \frac{ⅆ}{ⅆ z} F ( z ) , evaluated at z = {x}_{0} & if {x}_{0} = {x}_{1}\end{matrix}$$

A second program transformation creates a program that computes higher-order divided differences of F.

A third program transformation creates a program that computes higher-order divided differences of F more efficiently. (This transformation does not apply to all programs; however, we show that there is at least one important situation where this optimization is of use.)

A fourth program transformation generalizes the above techniques to handle functions of several variables.

These techniques for computational divided differencing can be used to create faster and/or more robust programs in scientific, engineering, and graphics applications.

### FIELD OF THE INVENTION

This invention concerns the manipulation and restructuring of programs that compute numerical functions using floating-point numbers, for the purpose of controlling round-off error. In particular, software that performs extrapolation and/or interpolation often requires divided differences to be computed; this can cause them to suffer badly from round-off error. In some cases, however, it is possible to systematically stabilize numerically unstable algorithms by computing divided differences in a non-standard way. The invention concerns automated approaches for restructuring a program to perform divided-difference computations in this non-standard way.

### BACKGROUND OF THE INVENTION

Because so much scientific, engineering, and graphical software tries to predict and render modeled situations, such software often performs extrapolation and/or interpolation. These operations often involve the computation of divided differences, which can suffer badly from round-off error. In some cases, which motivate the innovations described here, numerically unstable algorithms can be stabilized by computing divided differences in a non-standard way.

This invention concerns automated approaches for transforming programs that compute numerical functions into ones that compute divided differences by non-standard, but stable, methods. The various techniques that comprise the invention carry out high-level transformations that manipulate programs in semantically meaningful ways: in very general terms, each of our techniques transforms a program that performs a computation F(x) into a program that performs a related computation F^{#}(z), for a variety of F^{#}'s of interest. (In some cases, an appropriate preprocessing operation h needs to be applied to the input; in such cases, the transformed program F^{#} is used to perform a computation of the form F^{#}(h(x)).)

Terminology and Notation

In this document, we do not generally make a distinction between programs and procedures. We use “program” both to refer to the program as a whole, as well as to refer to individual subroutines in a generic sense. We use “procedure” only in places where we wish to emphasize that the focus of interest is an individual subroutine per se.

The example programs in the document are all written in C++, although the ideas described apply to other programming languages-including functional programming languages (cf. [Kar99, Kar01])—as well as to other imperative programming languages. The specific C++ declarations and code are to be understood as simply one possible embodiment of the invention. C++ is used here as a presentation notation in order to express precisely the way in which transformed programs behave. Embodiments of the invention based on other programming languages, programming-language notations, and programming constructs fall within the broader spirit and scope of the invention.

Throughout, Courier Font is used to denote functions defined by programs, whereas Italic Font is used to denote mathematical functions. That is, F(x) denotes a function (evaluated over real numbers), whereas F(x) denotes a program (evaluated over floating-point numbers). We adhere to this convention both in concrete examples that involve C++ code, as well as in more abstract discussions in order to distinguish between a mathematical function and a program that implements the function. To emphasize the links between mathematical concepts and their implementations in C++, we take the liberty of sometimes using ′ and/or subscripts on C++ identifiers.

We refer to both computational differentiation and computational divided differencing as “program transformations”, which may conjure up the image of tools that perform source-to-source rewriting fully automatically. Although this is one possible embodiment, in this document the term “transformation” will also include the use of C++ classes in which the arithmetic operators have been overloaded. With the latter approach, rewriting might be carried out by a preprocessor, but might also be performed by hand, since usually only light rewriting of the program source text is required.

Background on Computational Differentiation

One bright spot during the last thirty years with respect to the control of round-off error has been the emergence of tools for computational differentiation (also known as automatic differentiation or algorithmic differentiation) [Wen64, Ral81, GC92, BBCG96, Gri00], which transform a program that computes a numerical function F(x) into a related program that computes the derivative F′(x). Applications of computational differentiation include optimization, solving differential equations, curve fitting, and sensitivity analysis.

Computational-differentiation tools address the following issue: Suppose that you have a program F(x) that computes a numerical function F(x). It is a very bad idea to try to compute F′(x₀), the value of the derivative of F at x₀, by picking a small value delta_x and invoking the following program with the argument x₀:

| | |
|---|---|
| float delta_x = ...<some small value> ...; | (1) |
| float F'_naive(float x) { | |
| return (F(x + delta_x) − F(x))/delta_x; | |
| } | |

For a small enough value of delta_x, the values of F(x₀+delta_x) and F(x₀) will usually be very close. Round-off errors in the computation of F(x₀+delta_x) and F(x₀) are magnified by the subtraction of the two quantities, and further amplified by the division by the small quantity delta_x, which may cause the overall result to be useless. Computational differentiation sidesteps this problem by computing derivatives in another fashion.

Computational differentiation can be illustrated by means of the following example:

### EXAMPLE 1

Suppose that we have been given a collection of programs fᵢ for the functions fᵢ, 1≦i≦k, together with the program Prod shown below, which computes the function

$$Prod ( x ) = {\prod }_{i = 1}^{k} {f}_{i} ( x )$$

In addition, suppose that we have also been given programs fᵢ′ for the functions fᵢ′, 1≦i≦k. Finally, suppose that we wish to obtain a program Prod′ that computes the function Prod′(x). Column two of the table given below shows mathematical expressions for Prod(x) and Prod′(x). Column three shows two C++ procedures: Procedure Prod computes Prod(x); procedure Prod′ is the procedure that a computational-differentiation system would create to compute Prod′(x).

| | Mathematical Notation | Programming Notation |
|---|---|---|
| Function | $Prod ( x ) = {\prod }_{i = 1}^{k} {f}_{i} ( x )$ | $\begin{matrix}float Prod ( float x ) \{ \\ float ans = 1.0 ; \\ for ( int i = 1 ; i <= k ; i ++ ) \{ \\ ans = ans * {f}_{i} ( x ) ; \\ \} \\ return ans ; \\ \}\end{matrix}$ |
| Derivative | ${Prod}^{′} ( x ) = {\sum }_{i = 1}^{k} {f}_{i}^{′} ( x ) * {\prod }_{j \neq i} {f}_{i} ( x )$ | $\begin{matrix}float {Prod}^{′} ( float x ) \{ \\ float {ans}^{′} = 0.0 ; \\ float ans = 1.0 ; \\ for ( int i = 1 ; i <= k ; i ++ ) \{ \\ {ans}^{′} = {ans}^{′} * {f}_{i} ( x ) + ans * {f}_{i}^{′} ( x ) ; \\ ans = ans * {f}_{i} ( x ) ; \\ \} \\ return {ans}^{′} : \\ \}\end{matrix}$ |

Notice that program Prod′ resembles program Prod, as opposed to F′_naive (see box (1)). Prod′ preserves accuracy in its computation of the derivative because, as illustrated below in Example 2, it is based on the rules for the exact computation of derivatives, rather than on the kind of computation performed by F′_naive.

The transformation illustrated above is merely one instance of a general transformation that can be applied to any program: Given a program G as input, the transformation produces a derivative-computing program G′. The method for constructing G′ is as follows:

For each variable v of type float used in G, another float variable v′ is introduced.

Each statement in G of the form “v=exp;”, where exp is an arithmetic expression, is transformed into “v′=exp′; v=exp;”, where exp′ is the expression for the derivative of exp. If exp involves calls to a procedure g, then exp′ may involve calls to both g and g′.

Each return statement in G of the form “return v;” is transformed into “return v′;”.

In general, this transformation can be justified by appealing to the chain rule of differential calculus (see below).

### EXAMPLE 2

For Example 1, we can demonstrate the correctness of the transformation by symbolically executing Prod′ for a few iterations, comparing the values of ans′ and ans (as functions of x) at the start of each iteration of the for-loop:

| | Value of ans′ | |
|---|---|---|
| Iteration | (as a function of x) | Value of ans (as a function of x) |
| 0 | 0.0 | 1.0 |
| 1 | f′₁(x) | f₁(x) |
| 2 | f′₁(x) * f₂(x) + f₁(x) * f′₂(x) | f₁(x) * f₂(x) |
| 3 | f′₁(x) * f₂(x) * f₃(x) + | f₁(x) * f₂(x) * f₃(x) |
| | f₁(x) * f′₂(x) * f₃(x) + | |
| | f₁(x) * f₂(x) * f′₃(x) | |
| . . . | . . . | . . . |
| k | ${\sum }_{i = 1}^{k} {f}_{i}^{′} ( x ) * {\prod }_{j \neq i} {f}_{j} ( x )$ | ${\prod }_{i = 1}^{k} {f}_{i} ( x )$ |

The loop maintains the invariant that, at the start of each iteration,

$${ans}^{′} ( x ) = \frac{ⅆ}{ⅆ x} ans ( x ) .$$

(The value of ans′ on the 3^{rd} iteration would actually be computed with the terms grouped as follows: (f₁′(x)*f₂(x)+f₁(x)*f₂′(x))*f₃(x)+(f₁(x)*f₂(x))*f₃′(x). Terms have been expanded in the table given above to clarify how ans′ builds up a value that is equivalent—from the standpoint of evaluation in real arithmetic—

$$to {Prod}^{′} ( x ) = {\sum }_{i = 1}^{k} {f}_{i}^{′} ( x ) * {\prod }_{j \neq i}^{} {f}_{j} ( x ) . ) •$$

For the computational-differentiation approach, we did not really need to make the assumption that we were given programs fᵢ′ for the functions fᵢ′, 1≦i≦k; instead, the programs fᵢ′ can be generated from the programs fᵢ′ by applying the same statement-doubling transformation that was applied to Prod.

In languages that support operator overloading, such as C++, Ada, and Pascal-XSC, computational differentiation can be carried out by defining a new data type that has fields for both the value and the derivative, and overloading the arithmetic operators to carry out appropriate manipulations of both fields [Ral83, Ral84], along the lines of the definition of the C++ class FloatD, shown in FIG. 1. A class such as FloatD is called a differentiation arithmetic [Ral86, Ral90, Ral92].

The transformation then amounts to changing the types of each procedure's formal parameters, local variables, and return value (including those of the fᵢ)

### EXAMPLE 3

Using class FloatD, the Prod program of Example 1 can be handled as follows:

| | | |
|---|---|---|
| float f₁(float x) {...} | [symbol] | FloatD f₁(const FloatD &x) {...} |
| . | | . |
| . | | . |
| . | | . |
| float fₖ(float x) {...} | [symbol] | FloatD fₖ(const FloatD &x) {...} |
| float Prod(float x) { | | FloatD Prod(const FloatD &x) { |
| float ans = 1.0; | | FloatD ans(CONST, 1.0); // ans = 1.0 |
| for (int i = 1; i <= k; i++) { | | for (int i = 1; i <= k; i++) { |
| ans = ans * fᵢ(x); | [symbol] | ans = ans * fᵢ(x); |
| } | | } |
| return ans; | | return ans; |
| } | | } |
| | | float Prod'(float x) { |
| | | FloatD xD(VAR, x); |
| | [symbol] | return Prod(xD).val'; |
| | | } |

By changing the types of the formal parameters, local variables, and the return values of Prod and the fᵢ (and making a slight change to the initialization of ans in Prod), the program now carries around derivative values (in the val′ field) in addition to performing all of the work performed by the original program. Because of the C++ overload-resolution mechanism, the fᵢ procedures invoked in the fourth line of the transformed version of Prod are the transformed versions of the fᵢ (i.e., the fᵢ of type FloatD→FloatD).

The value of Prod's derivative at v is obtained by calling Prod′(v).

In a differentiation arithmetic, each procedure in the user's program, such as Prod and the fᵢ in Example 3, can be viewed as a box that maps two inputs to two outputs, as depicted in FIG. 2. In particular, in each differentiating version of a user-defined or library procedure F, the lower-right-hand output produces the value F′(v)*w.

An input value v for the formal parameter is treated as a pair (v, 1.0). Boxes like the one shown in FIG. 2 “snap together”: as shown in FIG. 3, when F is composed with G (and the input is v), the output value on the lower-right-hand side is F′(G (v))*G′(v), which agrees with the usual expression for the chain rule for the first-derivative operator.

The availability of overloading makes it possible to implement (forward-mode) computational differentiation conveniently, by packaging it as a differentiation-arithmetic class, as illustrated above. The alternative to the use of overloading is to build a special-purpose preprocessor to carry out the statement-doubling transformation that was illustrated in Examples 1 and 2. Examples of systems that use the latter approach include ADIFOR [BCC⁺92, BCKM96] and ADIC [BRM97].

Limitations of Computational Differentiation

This section discusses certain limitations of the computational-differentiation transformation. First, it is worthwhile mentioning that the presence of aliasing (e.g., due to pointers or reference parameters) is not a limitation of computational differentiation (nor of computational divided differencing): The transformations presented above (as well as the divided-differencing transformations discussed later in this document) work properly in the presence of aliasing (and are said to be alias-safe [Gri00]).

One limitation of computational differentiation comes from the fact that a program F′(x) that results from computational differentiation can perform additions and subtractions for which there are no analogues in the original program F(x). For instance, in program Prod′, an addition is performed in the statement

ans′=ans′* fᵢ(x)+ans*fᵢ′(x);

whereas no addition is performed in the statement

ans=ans*fᵢ(x);

Consequently, the result of evaluating F′(x) can be degraded by round-off error even when F(x) is computed accurately. However, the accuracy of the result from evaluating F′(x) can be verified by performing the same computation in interval arithmetic [Ral83, Ral92].

Another problem that arises is that the manner in which a function is programmed influences whether the results obtained from the derivative program are correct. For instance, for programs that use a conditional expression or conditional statement in which the condition depends on the independent variable—i.e., where the function is defined in a piecewise manner—the derivative program may not produce the correct answer.

### EXAMPLE 4

[Fis92]. Suppose that the function F(x)=x² is programmed using a conditional statement, as shown below on the left:

| | | |
|---|---|---|
| | | float F'(float x) { |
| | | float ans'; |
| float F(float x) { | | float ans; |
| float ans; | | if(x == 1.0) { |
| if(x == 1.0) { | | ans' = 0.0; |
| ans = 1.0; | | ans = 1.0; |
| } | [symbol] | } |
| else { | | else { |
| ans = x*x; | | ans' = x+x; |
| } | | ans = x*x; |
| return ans; | | } |
| } | | return ans'; |
| | | } |

Computational differentiation would produce the program shown above on the right. With this program, F′(1.0) returns 0.0, rather than the correct value of 2.0 (i.e., correct with respect to the meaning of the program as the mathematical function F(x)=x²).

The phenomenon illustrated in Example 4 has been called the branch problem or the if problem for computational differentiation. A more important example of the branch problem occurs in Gaussian elimination code, where pivoting introduces branches into the program [Fis92, BF94, Gri00]. Some additional problems that can arise with computational differentiation are identified in [Fis92]. A number of different approaches to these problems have been discussed in the literature [Fis92, BF94, SB96, Kea96, Gri00]. (Computational divided differencing also suffers from the branch problem.)

### SUMMARY OF THE INVENTION

The invention concerns the manipulation and restructuring of programs that compute numerical functions using floating-point numbers, for the purpose of controlling round-off error. In particular, it provides a variety of means for transforming a program that computes a numerical function F(x) into a related program that computes divided differences of F:

One such transformation creates a program that computes F[x₀, x₁], the first divided difference of F(x), where

$$F [ {x}_{0} , {x}_{1} ] {=}^{def} \{ \begin{matrix}\frac{F ( {x}_{0} ) - F ( {x}_{1} )}{{x}_{0} - {x}_{1}} & if {x}_{0} \neq {x}_{1} \\ \frac{ⅆ}{ⅆ z} F ( z ) , evaluated at z = {x}_{0} & if {x}_{0} = {x}_{1}\end{matrix}$$

(This transformation generalizes computational differentiation.)

A second program transformation creates a program that computes higher-order divided differences of F.

A third program transformation creates a program that computes higher-order divided differences of F more efficiently. (This transformation does not apply to all programs; however, we show that there is at least one important situation where this optimization is of use.)

A fourth program transformation generalizes the above techniques to handle functions of several variables.

Such program transformations can be implemented either as a source-to-source translation, or by means of overloaded operators and reinterpreted operands (in which case the source code is changed very little). The examples given below primarily illustrate the latter approach; they present sketches of implementations of the various transformations in the form of C++ class definitions (“divided-difference arithmetics”).

The benefits gained from this invention include the following:

Because divided differences are the basis for a wide variety of numerical techniques, including polynomial interpolation, numerical integration, and solving differential equations [CdB72], the invention can be used to create more robust programs in scientific, engineering, and graphics applications, when the function of interest is one that is defined by a program.

Finite differences on an evenly spaced grid can be used to quickly generate a function's values at any number of points that extend the grid (see [Gol77] and [PK82, pp. 403-404]). Because finite differences on an evenly spaced grid can be obtained from divided differences on an evenly spaced grid, the invention is useful in scientific, engineering, and graphics applications for quickly plotting or rendering functions (i.e., curves, surfaces, etc.), while retaining reasonable accuracy.

Because the divided-differencing problems that we address can be viewed as generalizations of problems such as differentiation, computation of Taylor coefficients, etc., some of our techniques—in particular, the divided-difference arithmetic presented in the section titled “Multi-Dimensional Computational Divided Differencing”—represent new approaches that, with appropriate simplification, can also be applied in computational-differentiation tools.

Empirical results presented later in the document provide three concrete demonstrations of some of the benefits that can be gained via use of the invention.

### BRIEF DESCRIPTION OF THE DRAWINGS

FIG. 1 shows a differentiation-arithmetic class.

FIG. 2 shows how in a differentiation arithmetic, each procedure in the user's program can be viewed as a box that maps two inputs to two outputs.

FIG. 3 illustrates how boxes like the one shown in FIG. 2 “snap together” when a function F is composed with G.

FIG. 4 presents the basic properties of the first-derivative and first-divided-difference operators.

FIG. 5 illustrates the result of applying the computational-differentiation and first-divided-difference transformations to member function Poly::Eval of Example 5.

FIG. 6 illustrates the relationships among F(x₀), F(x₀), F′(x₀), F′(x₀), F[x₀, x₁], and F[x₀, x₁].

FIG. 7 presents the basic properties of two divided-difference operators.

FIG. 8 presents class definitions for classes FloatDD and FloatV.

FIG. 9 gives implementations for the two constructors for class FloatDD.

FIG. 10 gives implementations for the four arithmetic operations of class FloatDD.

FIG. 11 shows the future values of $1 deposits made for 360 months, as computed via Eqn. (13) versus procedure FutureValue, for a variety of interest rates.

FIG. 12 presents the class definitions for class FloatDDR1.

FIG. 13 gives implementations for three of the arithmetic operations of class FloatDDR1.

FIG. 14 presents a method for tabulating the value of a polynomial at a number of evenly spaced points by evaluating the polynomial at each point.

FIG. 15 presents a method for tabulating the value of a polynomial P at a number of evenly spaced points via Briggs's method, where the the initial values in finite-difference table diffTable [ ] on entry to the Briggs tabulation loop are obtained by repeated application of the rule ΔₕP(X) [symbol] P(x+h)−P(x).

FIG. 16 presents a method for tabulating the value of a polynomial at a number of evenly spaced points via Briggs's method, where the the initial values in finite-difference table diffTable [ ] on entry to the Briggs tabulation loop are obtained via computational divided differencing.

FIG. 17 shows the matrix that completes Eqn. (19).

FIG. 18 presents definitions for class template DDArith<k>, and for classes DDArith<0>and IntVector.

FIG. 19 gives implementations for the four arithmetic operations of class template DDArith<k>.

FIG. 20 gives implementations for the constructors for class template DDArith<k>.

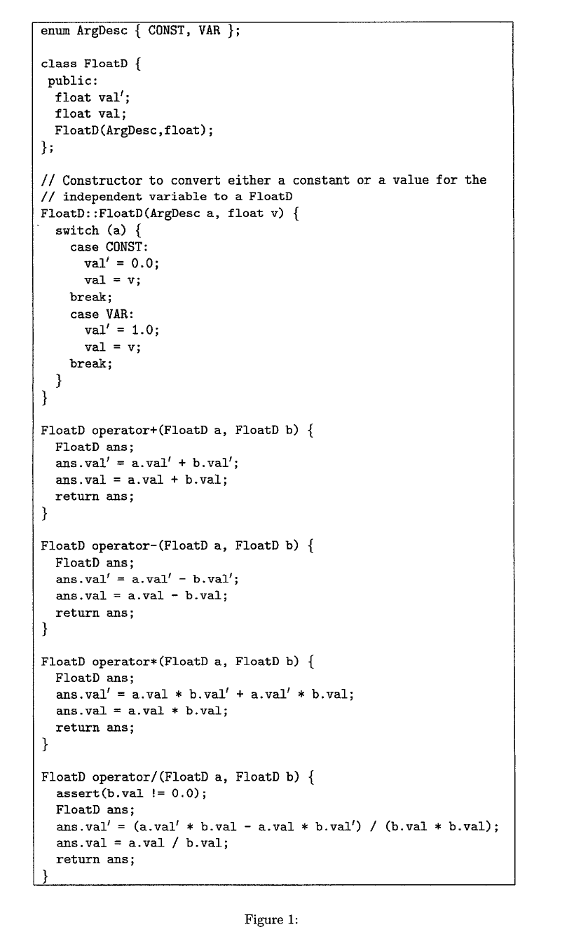

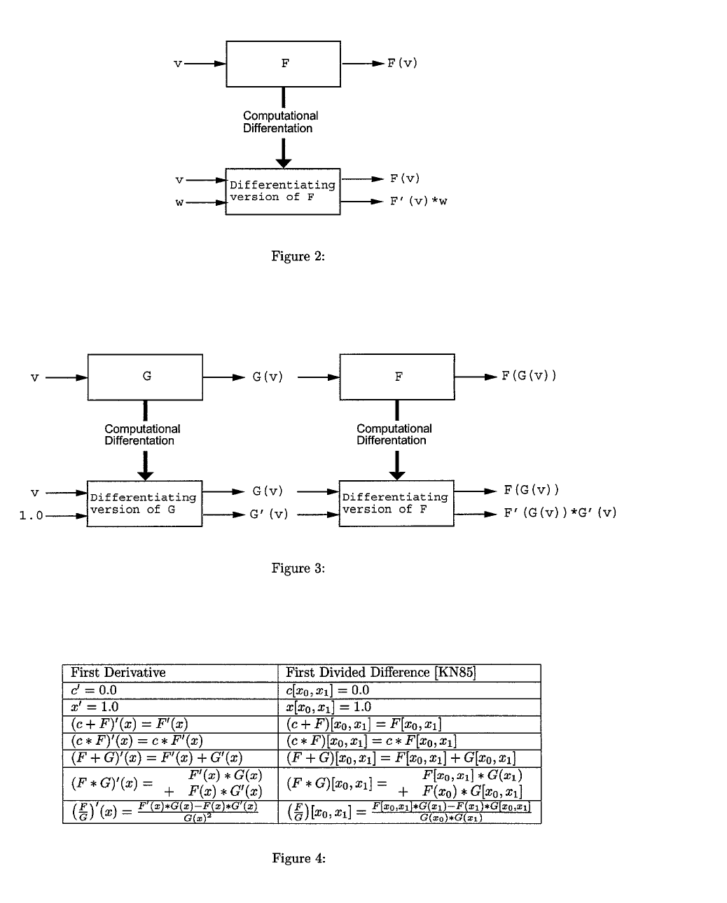

### DETAILED DESCRIPTION OF THE INVENTION

Computational Divided Differencing

In this invention, we exploit the principle on which computational differentiation is based—namely, that it is possible to differentiate entire programs, not just expressions—to develop a variety of new computational divided-differencing transformations. We develop several transformations that can be applied to numerical programs. One of these corresponds to the first-divided-difference operator, denoted by •[x₀, x₁] and defined as follows:

$$F [ {x}_{0} , {x}_{1} ] {=}^{def} \{ \begin{matrix}\frac{F ( {x}_{0} ) - F ( {x}_{1} )}{{x}_{0} - {x}_{1}} & if {x}_{0} \neq {x}_{1} \\ \frac{ⅆ}{ⅆ z} F ( z ) , evaluated at z = {x}_{0} & if {x}_{0} = {x}_{1}\end{matrix} \qquad ( 2 )$$

As with the differentiation operator, the problem that we face is that because division by a small value and subtraction are both operations that amplify accumulated round-off error, direct use of Eqn. (2) may lead to highly inaccurate results. In contrast, given a program that computes a numerical function F(x), our technique for computational first divided differencing creates a related program that computes F[x₀, x₁], but without directly evaluating the right-hand side of Eqn. (2).

As we show below, the program transformation that achieves this goal is quite similar to the transformation used in computational-differentiation tools. The transformed program sidesteps the explicit subtraction and division operations that appear in Eqn. (2), while producing answers that are equivalent (from the standpoint of evaluation in real arithmetic). The program that results thereby avoids many operations that could potentially amplify round-off error, and hence retains accuracy when evaluated in floating-point arithmetic.

To understand the basis of the idea, consider the case in which F(x)=x² and x₀≠x₁:

$$F [ {x}_{0} , {x}_{1} ] = \frac{F ( {x}_{0} ) - F ( {x}_{1} )}{{x}_{0} - {x}_{1}} = \frac{{x}_{0}^{2} - {x}_{1}^{2}}{{x}_{0} - {x}_{1}} = {x}_{0} + {x}_{1} . \qquad ( 3 )$$

That is, the first divided difference can be obtained by evaluating x₀+x₁. In general, for monomials we have:

| F(x) | c | x | x² | x³ | ... |
|---|---|---|---|---|---|
| F[x₀,x₁] | 0 | 1 | x₀ + x₁ | x²₀ + x₀x₁ + x₁² | ... |

Turning to programs, suppose that we are given the following program for squaring a number:

float Square(float x) {
return x * x;
}

The above discussion implies that to compute the first divided-difference of Square, we have our choice between the programs Square_{—}1DD_naive and Square_{—}1DD:

```
float Square_1DD_naive(float x0,float x1) {
  return (Square(x0) − Square(x1))/(x0 − x1);
}
float Square_1DD(float x0,float x1) {
  return x0 + x1;
}
```

However, the round-off-error characteristics of Square_{—}1DD are much better than those of Square_{—}1DD_naive.

The basis for creating expressions and programs that compute accurate divided differences is to be found in the basic properties of the first-divided-difference operator [KN85], which closely resemble those of the first-derivative operator, as shown in FIG. 4.

The program transformation for performing computational divided differencing can be explained by means of an example.

### EXAMPLE 5

Suppose that we have a C++ class Poly that represents polynomials, and a member function Poly::Eval that evaluates a polynomial via Horner's rule; i.e., it accumulates the answer by repeatedly multiplying by x and adding in the current coefficient, iterating down from the high-order coefficient:

| | |
|---|---|
| class Poly { | // Evaluation via Horner's rule |
| public: | float Poly::Eval(float x) { |
| float Eval(float); | float ans = 0.0; |
| private: | for (int i = degree; i >= 0; i−−) { |
| int degree; | ans = ans * x + coeff[i]; |
| // Array coeff [0..degree] | } return ans; |
| float *coeff; | } |
| }; | |

A new member function, Poly::Eval_{—}1DD, to compute the first divided difference can be created by transforming Poly::Eval as shown below:

| | |
|---|---|
| class Poly { | float Poly::Eval_1DD(float x0,float x1) { |
| public: | float ans_1DD = 0.0; |
| float Eval(float); | float ans = 0.0; |
| float Eval_1DD(float,float); | for (int i = degree; i >= 0; i−−) { |
| private: | ans_1DD = ans_1DD * x1 + ans; |
| int degree; | ans = ans * x0 + coeff[i]; |
| // Array coeff[0..degree] | } |
| float *coeff; | return ans_1DD; |
| }; | } |

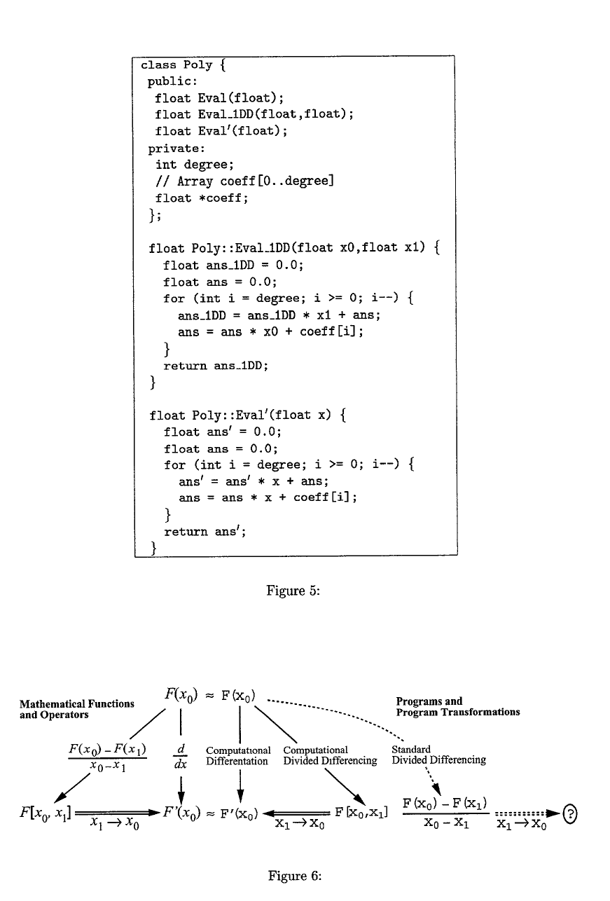

The transformation used to obtain Eval_{—}1DD from (the text of) Eval is similar to the computational-differentiation transformation that would be used to create a derivative-computing program Eval′ (Eval′ appears in FIG. 5):

Eval_{—}1DD is supplied with an additional formal parameter (and the two parameters are renamed x0 and x1).

For each local variable v of type float used in Eval, an additional float variable v_{—}1DD is introduced in Eval_{—}1DD.

Each statement of the form “v=exp;” in Eval is transformed into “v_{—}1DD=exp[x0,x1]; v=exp₀;”, where exp[x0,x1] is the expression for the divided difference of exp, and exp₀ is exp with x0 substituted for all occurrences of x.

Each statement of the form “return v” in Eval is transformed into “return v_{—}1DD”.

One caveat concerning the transformation presented above should be noted: the transformation applies only to procedures that have a certain special syntactic structure—namely, the only multiplication operations that depend on the independent variable x must be multiplications on the right by x. Procedure Eval is an example of a procedure that has this property.

A different, but similar, transformation can be used if all of the multiplication operations that depend on the independent variable x are multiplications on the left by x. (This point is discussed further in Example 11.) It is also possible to give a fully general first-divided-difference transformation; however, this transformation can be viewed as a special case of the material presented in the section titled “Higher-Order Computational Divided Differencing”. Consequently, we will not pause to present the general first-divided-difference transformation here.

Alternatively, as with computational differentiation, for languages that support operator over-loading, computational divided differencing can be carried out with the aid of a new class, say Float1DD, for which the arithmetic operators are appropriately redefined. (We will call such a class a divided-difference arithmetic.) Computational divided differencing is then carried out by making appropriate changes to the types of each procedure's formal parameters, local variables, and return value.

Again, definitions of first-divided-difference arithmetic classes—both for the case of general first divided differences, as well as for the special case that covers programs like Eval—can be viewed as special cases of the divided-difference arithmetic classes FloatDD and FloatDDR1 discussed in the sections titled “Higher-Order Computational Divided Differencing” and “A Special Case”, respectively. For this reason, we postpone giving a concrete example of a divided-difference arithmetic until the discussion of class FloatDD.

Computational Divided Differencing as a Generalization of Computational Differentiation

In this section, we explain in what sense computational divided differencing can be said to generalize computational differentiation. First, observe that over real numbers, we have

$${lim}_{{x}_{1} -> {x}_{0}} F [ {x}_{0} , {x}_{1} ] = {lim}_{{x}_{1} -> {x}_{0}} \frac{F ( {x}_{0} ) - F ( {x}_{1} )}{{x}_{0} - {x}_{1}} = {F}^{′} ( {x}_{0} ) . \qquad ( 4 )$$

However, although Eqn. (4) holds over reals, it does not hold over floating-point numbers: as x₁ approaches x₀, because of accumulated round-off error, the quantity

$$\frac{F ( {x}_{0} ) - F ( {x}_{1} )}{{x}_{0} - {x}_{1}} does not ,$$

in general, approach F′(x₀). (Note the use of Courier Font here; this is a statement about quantities computed by programs.) This is why derivatives cannot be computed accurately by procedure F′_naive (see box (1)).

In contrast, for the programs F[x₀, x₁] and F′(x₀), we do have the property that

$${lim}_{{x}_{1} -> {x}_{0}} F [ {x}_{0} , {x}_{1} ] = {F}^{′} ( {x}_{0} ) . \qquad ( 5 )$$

More precisely, the property that holds is that we have equality when x₁ equals x₀:

F[x₀, x₀]=F′(x₀). (6)

### EXAMPLE 6

To illustrate Eqn. (6), consider applying the two transformations to member function Poly::Eval of Example 5; the result is shown in FIG. 5. When formal parameters x0, x1, and x all have the same value—say v—then exactly the same operations are performed by Eval_{—}1DD(v, v) and Eval′(v).

Because computations are carried out over floating-point numbers, the programs F[x₀, x₁] and F′(x₀) are only approximations to the functions that we actually desire. That is, F[x₀, x₁] approximates the function F[x₀, x₁], and F′(x₀) approximates F′(x₀). The relationships among these functions and programs are depicted in FIG. 6. As the discussion above has noted, the interesting feature of this diagram is the relationship between F[x₀, x₁] and F′(x₀), on the side of the diagram labeled “Programs and Program Transformations”. In particular, as x₁ approaches x₀, F[x₀, x₁] approaches F′(x₀). Consequently, a program produced by a system for computational divided differencing can be used to compute values of derivatives (in addition to divided differences) by feeding it duplicate actual parameters (e.g., Eval_{—}1DD(v, v)). In contrast, a program created by means of computational differentiation can only produce derivatives (and not divided differences). In this sense, computational divided differencing can be said to generalize computational differentiation.

Computational divided differencing suffers from one of the same problems that arises with computational differentiation—namely that the program F[x₀,x₁] that results from the transformation can perform additions and subtractions that have no analogues in the original program F(x) (see the discussion in the section titled “Limitations of Computational Differentiation”). Consequently, the result of evaluating F[x₀, x₁] can be degraded by round-off error even when F(x) is computed accurately. However, computational divided differencing is no worse in this regard than computational differentiation. Moreover, because of the fact that F[x₀, x₁] converges to F′(x₀) as x₁ approaches x₀, if F′(x₀) returns a result of sufficient accuracy, then F[x₀, x₁] will return a result of sufficient accuracy when |x₀−x₁| is small. Higher-Order Computational Divided Differencing

In this section, we show that the program transformation that was introduced to perform computational divided differencing can be generalized to define a transformation for higher-order computational divided differencing. To do so, we will define a divided-difference arithmetic that manipulates divided-difference tables.

Higher-order divided differences are divided differences of divided differences, defined recursively as follows:

$$\begin{matrix}F [ {x}_{i} ] {=}^{def} F ( {x}_{i} ) & ( 7 ) \\ F [ {x}_{0} , {x}_{1} , … , {x}_{n - 1} , {x}_{n} ] {=}^{def} \{ \begin{matrix}\frac{F [ {x}_{0} , {x}_{1} , … , {x}_{n - 1} ] - F [ {x}_{1} , … , {x}_{n - 1} , {x}_{n} ]}{{x}_{0} - {x}_{n}} & if {x}_{0} \neq {x}_{n} \\ \frac{\partial }{\partial z} F [ z , {x}_{1} , … , {x}_{n - 1} ] {\vert}_{z = {x}_{0}} & if {x}_{0} = {x}_{n}\end{matrix} & ( 8 )\end{matrix}$$

Higher-order divided differences have numerous applications in interpolation and approximation of functions [CdB72].

In our context, a divided-difference table for a function F is an upper-triangular matrix whose entries are divided differences of different orders, as indicated below:

$$( \begin{matrix}F ( {x}_{0} ) & F [ {x}_{0} , {x}_{1} ] & F [ {x}_{0} , {x}_{1} , {x}_{2} ] & F [ {x}_{0} , {x}_{1} , {x}_{2} , {x}_{3} ] \\ 0 & F ( {x}_{1} ) & F [ {x}_{1} , {x}_{2} ] & F [ {x}_{1} , {x}_{2} , {x}_{3} ] \\ 0 & 0 & F ( {x}_{2} ) & F [ {x}_{2} , {x}_{3} ] \\ 0 & 0 & 0 & F ( {x}_{3} )\end{matrix} ) \qquad ( 9 )$$

Other arrangements of F's higher-order divided differences into matrix form are possible. For example, one could have a lower triangular matrix with the F(xᵢ) running down the first column. However, the use of the arrangement shown in Eqn. (9) is key to being able to use simple notation—i.e., ordinary matrix operations—to describe our methods [Opi64].

It is worthwhile mentioning here that higher-order divided differences are symmetric in the xₖ; that is, for any permutation π of the sequence [0, . . . ,n],

F[x₀, x₁, . . . , xₙ]=F[x_{π(0)}, x_{π(1)}, . . . x_{π(n)}].

Notation that emphasized the order-independence of the xₖ, such as F{x₀, x₁, . . . , xₙ}, might have been employed. However, the arrangement of higher-order divided differences into the form shown in Eqn. (9)—together with the use of ordinary matrix operations—imposes some order on the diagonal elements, say, F(x₀), F(x₁), . . . , F(xₙ). Our notation, therefore, will always reflect this order: for 0≦i≦j≦n, the (i,j) element of a divided-difference table whose diagonal elements are F(x₀), F(x₁), . . . , F(xₙ) is denoted by F[xᵢ, xᵢ₊₁, . . . , xⱼ], where the sequence [i, i+1, . . . , j] is a contiguous subsequence of [0, . . . , n].

We occasionally use [x_{i,j}] as an abbreviation for [xᵢ, . . . , xⱼ]. However, it should be noted that

$$\begin{matrix}F [ {x}_{0 , 2} ] = F [ {x}_{0} , {x}_{1} , {x}_{2} ] \\ = \frac{F [ {x}_{0} , {x}_{1} ] - F [ {x}_{1} , {x}_{2} ]}{{x}_{0} - {x}_{2}} ,\end{matrix}$$

which is not the same as F[x₀,x₂]:

$$F [ {x}_{0} , {x}_{2} ] = \frac{F ( {x}_{0} ) - F ( {x}_{2} )}{{x}_{0} - {x}_{2}} .$$

We use • [symbol] ^{[x}^{₀}^{, . . . ,x}^{ₙ}^{]} to denote the operator that yields the divided-difference table for a function with respect to points x₀, . . . , xₙ (We use • [symbol] if the points x₀, . . . , xₙ are clear from the context.)

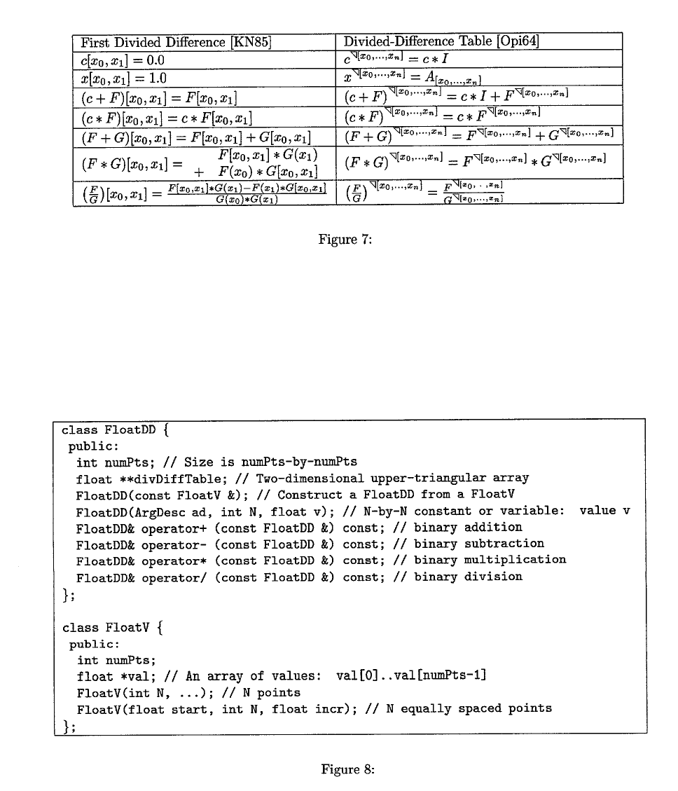

A method for creating accurate divided-difference tables for rational expressions is found in Opitz [Opi64]. This method is based on the properties of • [symbol] ^{[x}^{₀}^{, . . . ,x}^{ₙ}^{]} given in the right-hand column of FIG. 7. A few items in FIG. 7 require explanation:

The symbol I denotes the identity matrix.

The symbol A_{[x}_{₀}_{, . . . ,x}_{ₙ}_{]} denotes the matrix

$$( \begin{matrix}{x}_{0} & 1 & 0 & ⋯ & 0 \\ 0 & {x}_{1} & 1 & ⋯ & 0 \\ ⋮ & ⋰ & ⋰ & ⋰ & ⋮ \\ 0 & ⋯ & ⋰ & {x}_{n - 1} & 1 \\ 0 & ⋯ & ⋯ & 0 & {x}_{n}\end{matrix} ) . \qquad ( 10 )$$

In the entry for (F*G) [symbol] ^{[x}^{₀}^{, . . . ,x}^{ₙ}^{]}, the multiplication operation in F [symbol] ^{[x}^{₀}^{, . . . ,x}^{ₙ}^{]}*G [symbol] ^{[x}^{₀}^{, . . . ,x}^{ₙ}^{]} is matrix multiplication.

In the entry for

$${( \frac{F}{G} )}^{ [ {x}_{0} , … , {x}_{n} ]} ,$$

the division operation in

$$\frac{{F}^{ [ {x}_{0} , , {x}_{n} ]}}{{G}^{ [ {x}_{0} , . , {x}_{n} ]}}$$

is matrix division

$$( i . e . , \frac{P}{Q} = P * {Q}^{- 1} ) .$$

The two columns of the table shown in FIG. 7 can be read as recursive definitions for the operations •[x₀, x₁] and • [symbol] ^{[x}^{₀}^{, . . . ,x}^{ₙ}^{]}, respectively. These have straightforward implementations as recursive programs that walk over an expression tree. Note that the •[x₀, x₁] operation defined in the first column of FIG. 7 creates an expression that computes only the first divided difference of the original expression e(x), whereas the operation defined in the second column of FIG. 7 creates a (matrix) expression that computes all of the first, second, . . . , n^{th} divided differences with respect to the points x₀, x₁, . . . , xₙ, as well as n+1 values of e(x). In particular, in the matrix that results from evaluating the transformed expression, the values of e(x) evaluated at the points x₀, x₁, . . . , xₙ are found on the diagonal. For instance, in the case of an expression that multiplies two subexpressions F(x) and G(x), the elements on the diagonal are F(x₀)*G(x₀), F(x₁)*G(x₁), . . . , F(xₙ)*G(xₙ). It is easy to verify (by means of induction) that the first and second columns of the table shown in FIG. 7 are consistent with each other: in each case, the quantity e[x₀,x₁] represents the (0,1) entry of the matrix e [symbol] ^{[x}^{₀}^{, . . . ,x}^{ₙ}^{]}.

The second column of the table shown in FIG. 7 has an even more straightforward interpretation:

Observation 7 [Reinterpretation Principle]. The divided-difference table of an arithmetic expression e(x) with respect to the n+1 points x₀, . . . , xₙ can be obtained by reinterpreting e(x) as a matrix expression, where the matrix A_{[x}_{₀}_{, . . . ,x}_{ₙ}_{]} is used at each occurrence of the variable x, and c*I is used at each occurrence of a constant c.

That is, the expression tree for e(x) is unchanged-except at its leaves, where A_{[x}_{₀}_{, . . . ,x}_{ₙ}_{]} is used in place of x, and c*I is used in place of abut the operators at all internal nodes are reinterpreted as denoting matrix operations. This observation is due to Opitz [Opi64].

With only a slight abuse of notation, we can express this as

e [symbol] ^{[x}^{₀}^{, . . . ,x}^{ₙ}^{]}=e(A_{[x}_{₀}_{, . . . ,x}_{ₙ}_{]}).

Using this notation, we can show that the chain rule for the divided-difference operator • [symbol] ^{[x}^{₀}^{, . . . ,x}^{ₙ}^{]} has the following particularly simple form:

$$\begin{matrix}{( F ∘ G )}^{ [ {x}_{0} , … , {x}_{n} ]} = ( F ∘ G ) ( {A}_{[ {x}_{0} , … , {x}_{n} ]} ) \\ = F ( G ( {A}_{[ {x}_{0} , … , {x}_{n} ]} ) ) \\ = F ( {G}^{ [ {x}_{0} , … , {x}_{n} ]} ) .\end{matrix}$$

Opitz's approach can be extended to the creation of accurate divided-difference tables for functions defined by programs by overloading the arithmetic operators used in the program to be matrix operators—i.e., by defining a divided-difference arithmetic that manipulates divided-difference tables:

Observation 8 [Computational Divided-Differencing Principle]. Rather than computing a divided-difference table with respect to the points x₀, x₁, . . . , xₙ by invoking the program n+1 times and then applying Eqns. (7) and (8), we may instead evaluate the program (once) using a divided-difference arithmetic that overloads arithmetic operations as matrix operations, substituting A_{[x}_{₀}_{, . . . ,x}_{ₙ}_{]} for each occurrence of the formal parameter x, and c*I for each occurrence of a constant c.

Note that the single invocation of the program using the divided-difference arithmetic will actually be more expensive than the n+1 ordinary invocations of the program. The advantage of using divided-difference arithmetic is not that execution is speeded up because the program is only invoked once (in fact, execution is slower); the advantage is that the result computed using divided-difference arithmetic is much more accurate.

Because higher-order divided differences are defined recursively in terms of divided differences of lower order (cf. Eqns. (7) and (8)), it would be possible to define an algorithm for higher-order computational-divided-differencing using repeated applications of lower-order computational-divided-differencing transformations. However, with each application of the transformation for computational first divided differencing, the program that results performs (roughly) three times the number of operations that are performed by the program the transformation starts with. Consequently, this approach has a significant drawback: the final program that would be created for computing k^{th} divided differences could be O(3^{k}) times slower than the original program. In contrast, the slow-down factor with the approach based on Observation 8 is O(k³).

We now describe how a version of higher-order computational divided differencing based on Observation 8 can be implemented in C++. Below, we present highlights of a divided-difference arithmetic class, named FloatDD. We actually make use of two classes: (i) class FloatDD, the divided-difference arithmetic proper, and (ii) class FloatV, vectors of xᵢ values. These classes are defined in FIG. 8.

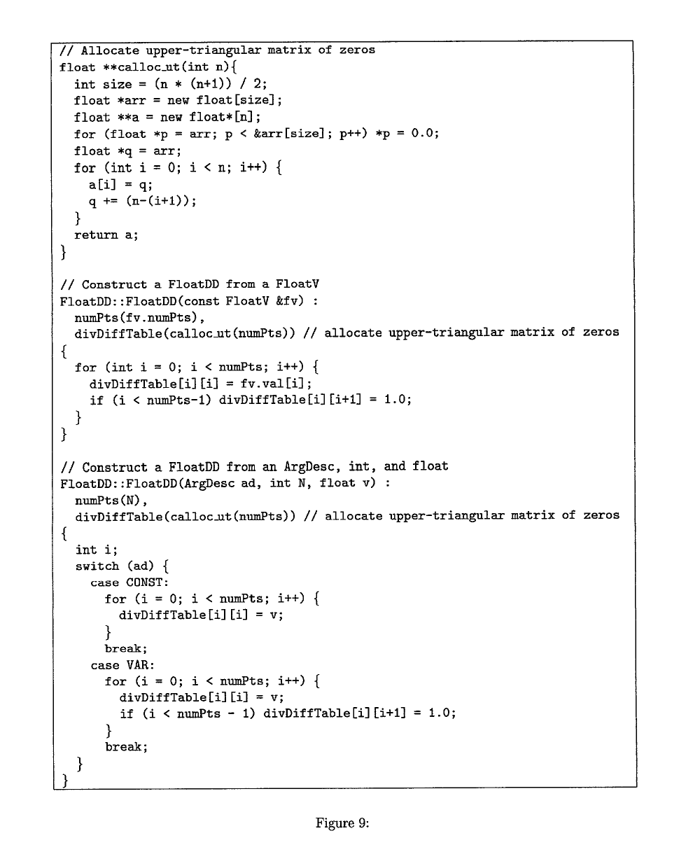

The constructor FloatDD(const FloatV &), defined in FIG. 9, plays the role of generating a matrix A_{[x}_{₀}_{, . . . ,x}_{ₙ}_{]} from a vector [x₀, . . . ,xₙ] of values for the independent variable. (The procedure calloc_ut of FIG. 9 allocates an upper-triangular matrix in such a way that ordinary array-indexing operations can be used to access the elements; all elements of the matrix are initialized to zero.) The constructor FloatDD(ArgDesc ad, int N, float v), also defined in FIG. 9, generates either the matrix A_{[v, . . . ,v]} of size N-by-N or the matrix v*I of size N-by-N, depending on the value of parameter ad.

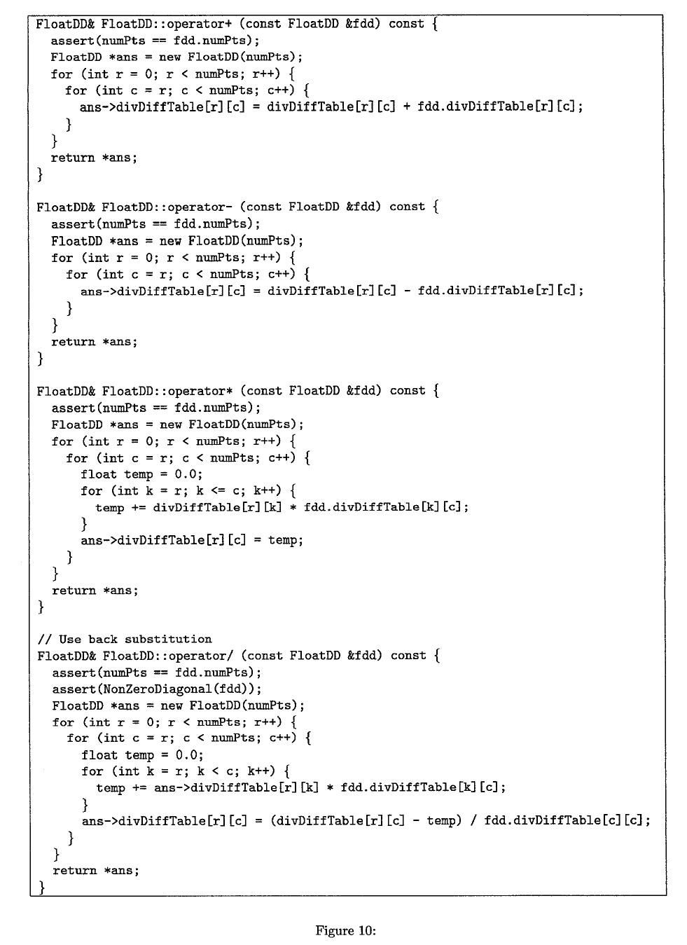

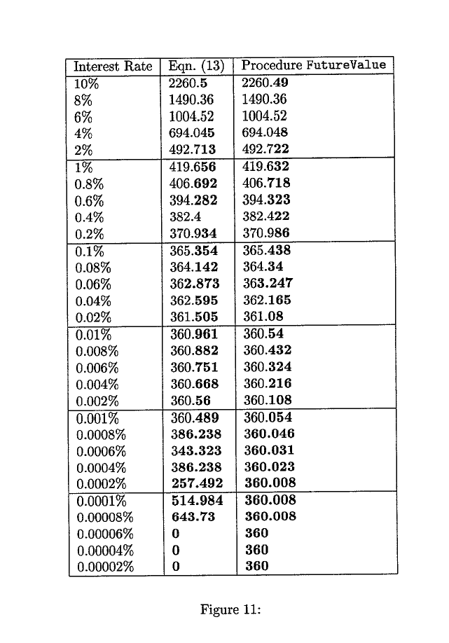

The four arithmetic operations of class FloatDD are defined in FIG. 10. The addition, sub traction, multiplication, and division operators of class FloatDD simply perform corresponding the matrix operations. The division operator of class FloatDD is implemented using back substitution. That is, suppose we wish to find the value of A/B (call this value X). X can be found by solving the system X*B=A. Because the divided-difference tables A and B are both upper-triangular matrices, this can be done using back substitution, as shown in FIG. 10.

### EXAMPLE 9

To illustrate these definitions, consider again the procedure Poly::Eval that evaluates a polynomial via Horner's rule. Computational divided differencing is carried out by changing the types of Eval's formal parameters, local variables, and return value from float to FloatDD:

| | | |
|---|---|---|
| // Evaluation via Horner's rule | | // Evaluation via Horner's rule |
| float Poly::Eval(float x) { | | FloatDD Poly::Eval(const FloatDD &x) { |
| float ans = 0.0; | | FloatDD ans(x.numPts); // ans = 0.0 |
| for (int i = degree; i >= 0; i−−) { | [symbol] | for (int i = degree; i >= 0; i−−) { |
| ans = ans * x + coeff[i]; | | ans = ans * x + coeff[i]; |
| } | | } |
| return ans; | | return ans; |
| } | | } |

The transformed procedure can be used to generate the divided-difference table for the polynomial

P(x)=2.1*x³−1.4*x²−0.6*x+1.1

with respect to the (unevenly spaced) points 3.0, 3.01, 3.02, 3.05 by performing the following operations:

Poly *P = new Poly(4,2.1,−1.4,−0.6,1.1);
FloatV x(4,3.0,3.01,3.02,3.05);
FloatDD A(x); // Corresponds to A_{[x0,...,x3]}
FloatDD fdd = P−>Eval(A);

We now present some empirical results that illustrate the advantages of the computational-divided-differencing method. In this experiment, we worked with the polynomial

P(x)=2.1*x³−1.4*x²−0.6*x+1.1,

and performed computations on a Sun SPARCstation 20/61 running SunOS 5.6. Programs were compiled with the egcs-2.91.66 version of g++ (egcs-1.1.2 release). The experiment compared the standard method for generating divided-difference tables—namely, the recursive definition given by Eqn. (7) and the first line of Eqn. (8)—against the overloaded version of procedure Poly::Eval from Example 9 (which was invoked using code like the fragment shown in box (11)) using single-precision and double-precision floating-point arithmetic.

In each of the examples shown below, the values used for the (unevenly spaced) points x₀, x₁, x₂, and x₃ are shown on the left. Note how the standard method for generating divided-difference tables degrades as the points move closer together. (Places where the results from the two methods differ are indicated in boldface.)

| | Computational Divided Differencing | Standard Divided Differencing |
|---|---|---|
| | (single-precision arithmetic) | (single-precision arithmetic) |
| $\begin{matrix}{x}_{0} : & 3.0 \\ {x}_{1} : & 4.0 \\ {x}_{2} : & 5.0 \\ {x}_{3} : & 7.0\end{matrix}$ | $( \begin{matrix}43.4 & 67.3 & 23.8 & 2.1 \\ & 110.7 & 114.9 & 32.2 \\ & & 225.6 & 211.5 \\ & & & 648.6\end{matrix} )$ | $( \begin{matrix}43.4 & 67.3 & 23.8 & 2.09999 \\ & 110.7 & 114.9 & 32.2 \\ & & 225.6 & 211.5 \\ & & & 648.6\end{matrix} )$ |
| $\begin{matrix}{x}_{0} : & 3.0 \\ {x}_{1} : & 3.01 \\ {x}_{2} : & 3.02 \\ {x}_{3} : & 3.05\end{matrix}$ | $( \begin{matrix}43.4 & 47.8752 & 17.563 & 2.1 \\ & 43.8787 & 48.2265 & 17.668 \\ & & 44.361 & 48.9332 \\ & & & 45.829\end{matrix} )$ | $( \begin{matrix}43.4 & 47.8749 & 17.5858 & 1.59073 \\ & 43.8787 & 48.2266 & 17.6653 \\ & & 44.361 & 48.9332 \\ & & & 45.829\end{matrix} )$ |
| $\begin{matrix}{x}_{0} : & 3.0 \\ {x}_{1} : & 3.001 \\ {x}_{2} : & 3.002 \\ {x}_{3} : & 3.005\end{matrix}$ | $( \begin{matrix}43.4 & 47.7175 & 17.5063 & 2.1 \\ & 43.477 & 47.7525 & 17.5168 \\ & & 43.4955 & 47.8226 \\ & & & 43.6389\end{matrix} )$ | $( \begin{matrix}43.4 & 47.7177 & 15.2886 & 754.685 \\ & 43.4477 & 47.7483 & 19.0621 \\ & & 43.4955 & 47.8245 \\ & & & 43.6389\end{matrix} )$ |
| $\begin{matrix}{x}_{0} : & 3.0 \\ {x}_{1} : & 3.0001 \\ {x}_{2} : & 3.0002 \\ {x}_{3} : & 3.0005\end{matrix}$ | $( \begin{matrix}43.4 & 47.7017 & 17.5006 & 2.1 \\ & 43.4048 & 47.7052 & 17.5017 \\ & & 43.4095 & 47.7122 \\ & & & 43.4238\end{matrix} )$ | $( \begin{matrix}43.4 & 47.6945 & 3.62336 & 117520 \\ & 43.4048 & 47.6952 & 62.379 \\ & & 43.4095 & 47.7202 \\ & & & 43.4238\end{matrix} )$ |

In particular, because P is a cubic polynomial whose high-order coefficient is 2.1, the proper value of P[x₀, x₁, x₂, x₃]—the third divided difference of P—is 2.1, not 117,520! (Compare the entries that appear in the upper-right-hand corners of the fourth pair of divided-difference tables shown above.)

Switching to double-precision arithmetic, and continuing to move the points closer together, we obtain:

| | Computational Divided Differencing | Standard Divided Differencing |
|---|---|---|
| | (double-precision arithmetic) | (double-precision arithmetic) |
| $\begin{matrix}{x}_{0} : & 3.0 \\ {x}_{1} : & 3.0001 \\ {x}_{2} : & 3.0002 \\ {x}_{3} : & 3.0005\end{matrix}$ | $( \begin{matrix}43.4 & 47.7018 & 17.5006 & 2.1 \\ & 43.4048 & 47.7053 & 17.5017 \\ & & 43.4095 & 47.7123 \\ & & & 43.4239\end{matrix} )$ | $( \begin{matrix}43.4 & 47.7018 & 17.5006 & 2.10121 \\ & 43.4048 & 47.7053 & 17.5017 \\ & & 43.4095 & 47.7123 \\ & & & 43.4239\end{matrix} )$ |
| $\begin{matrix}{x}_{0} : & 3.0 \\ {x}_{1} : & 3.00001 \\ {x}_{2} : & 3.00002 \\ {x}_{3} : & 3.00005\end{matrix}$ | $( \begin{matrix}43.4 & 47.7002 & 17.5001 & 2.1 \\ & 43.4005 & 47.7005 & 17.5002 \\ & & 43.4001 & 47.7012 \\ & & & 43.4024\end{matrix} )$ | $( \begin{matrix}43.4 & 47.7002 & 17.5001 & 1.89257 \\ & 43.4005 & 47.7005 & 17.5002 \\ & & 43.4001 & 47.7012 \\ & & & 43.4024\end{matrix} )$ |
| $\begin{matrix}{x}_{0} : & 3.0 \\ {x}_{1} : & 3.000001 \\ {x}_{2} : & 3.000002 \\ {x}_{3} : & 3.000005\end{matrix}$ | $( \begin{matrix}43.4 & 47.7 & 17.5 & 2.1 \\ & 43.4 & 47.7001 & 17.5 \\ & & 43.4001 & 47.7001 \\ & & & 43.4002\end{matrix} )$ | $( \begin{matrix}43.4 & 47.7 & 17.5077 & - 1640.17 \\ & 43.4 & 47.7001 & 17.4995 \\ & & 43.4001 & 47.7001 \\ & & & 43.4002\end{matrix} )$ |

Finally, with either single-precision or double-precision arithmetic, when we set all of the input values to 3.0, we obtain Computational Divided Differencing Standard Divided Differencing

| | Computational | Standard |
|---|---|---|
| | Divided Differencing | Divided Differencing |
| $\begin{matrix}{x}_{0} : & 3.0 \\ {x}_{1} : & 3.0 \\ {x}_{2} : & 3.0 \\ {x}_{3} : & 3.0\end{matrix}$ | $( \begin{matrix}43.4 & 47.7 & 17.5 & 2.1 \\ & 43.4 & 47.7 & 17.5 \\ & & 43.4 & 47.7 \\ & & & 43.4\end{matrix} )$ | $( \begin{matrix}43.4 & NaN & NaN & NaN \\ & 43.4 & NaN & NaN \\ & & 43.4 & NaN \\ & & & 43.4\end{matrix} )$ |

With the standard divided-differencing method, division by 0 occurs and yields the exceptional value NaN. In contrast, computational divided differencing produces values for P's first, second, and third derivatives. More precisely, each k^{th} divided-difference entry in the computational-divided-differencing table equals

$$\frac{1}{k !} \frac{{ⅆ}^{k} P ( x )}{ⅆ {x}^{k}} {\vert}_{x = 3.0} \qquad ( 12 )$$

The k=1 case was already discussed in the section titled “Computational Divided Differencing as a Generalization of Computational Differentiation”, where we observed that computational first divided differencing could be used to compute first derivatives.

### EXAMPLE 10

Suppose that we wish to compute the future value of n monthly payments, each of 1 unit, paid at the end of each month into a savings account that compounds interest at the rate of α per month (where α is a small positive value and n is a positive integer). This answers the question “How many dollars are accumulated after n months, when you deposit $1 per month for n months, into a savings account that pays annual interest at the rate of (12×α×100)%, compounded monthly?” Future value can be computed by the function

$$FutureValue ( α , n ) {=}^{def} \frac{( {( 1 + α )}^{n} - 1 )}{α} . \qquad ( 13 )$$

However, this can also be written as

$$FutureValue ( α , n ) = \frac{( {( 1 + α )}^{n} - {1}^{n} )}{( 1 + α ) - 1} ,$$

and thus is equal to the following first-divided difference of the power function:

Future Value(α, n)=(xⁿ))[1+α, 1]. (14)

The latter quantity can be computed to nearly full accuracy using computational divided differencing by computing (xⁿ) [symbol] ^{[1+α, 1]}, and then extracting the (0, 1) entry. For instance, we can start with the following procedure power, which computes xⁿ via repeated squaring and multiplication by x, according to the bits of argument n:

const unsigned int num_bits = sizeof(unsigned int)*8;
float power(float x, unsigned int n) {

unsigned int mask = 1 << (num_bits − 1);
float ans = 1.0;
for (unsigned int i = 0; i < num_bits; i++) {

ans = ans * ans;
if (mask & n) ans = ans * x;
mask >>= 1;

}
return ans;

}

By changing the types of power's formal parameters, local variables, and return value, we create a version that computes a divided-difference table:

FloatDD power(FloatV &x, unsigned int n) {

unsigned int mask = 1 << (num_bits − 1);
FloatDD ans(CONST, 2, 1.0); // ans = 1.0
for (unsigned int i = 0; i < num_bits; i++) {

ans = ans * ans;
if (mask & n) ans = ans * x;
mask >>= 1;

}
return ans;

}

The transformed procedure can be used to compute the desired computation to nearly full accuracy by calling the procedure FutureValue that is defined below:

float FutureValue(float alpha, unsigned int n) {

float w[2] = { 1+alpha, 1 };
FloatV v(2, w);
return power(v,n).divDiffTable[0][1];

}

FIG. 11 presents some empirical results that illustrate the advantages of this approach. In this experiment, we performed computations using single-precision floating-point arithmetic on a Sony VAIO PCG-Z505JSK (650 MHz Intel Pentium III processor) running Windows 2000. Programs were compiled with Microsoft Visual C++ 6.0. The table given in FIG. 11 shows the future values of $1 deposits made for 360 months, as computed via Eqn. (13) versus procedure FutureValue, for a variety of interest rates. (Places where the results from the two methods differ are indicated in boldface in FIG. 11.)

A Special Case

A divided-difference table for a function F can be thought of as a (redundant) representation of an interpolating polynomial for F. For instance, if you have a divided-difference table T (and also know the appropriate vector of values x₀, x₁, . . . , xₙ), you can explicitly construct the Newton form of the interpolating polynomial for F according to the following definition [CdB72, pp. 197]:

$${p}_{n} ( x ) = {\sum }_{i = 0}^{n} F [ {x}_{0} , … , {x}_{i} ] * {\prod }_{j = 0}^{i - 1} ( x - {x}_{j} ) \qquad ( 15 )$$

Note that to be able to create the Newton form of the interpolating polynomial for F via Eqn. (15), only the first row of divided-difference table T is required to be at hand—i.e., the values F[x₀, . . . , xᵢ], for 0≦i≦n—together with the values of x₀, x₁, . . . , xₙ. This observation suggests that we should develop an alternative divided-difference arithmetic that builds up and manipulates only first rows of divided-difference tables. We call this divided-difference arithmetic FloatDDR1 (for Divided-Difference Row 1). The motivation for this approach is that FloatDDR1 operations will be much faster than FloatDD ones, because FloatDD operations must manipulate upper-triangular matrices, whereas FloatDDR1 operations involve only simple vectors.

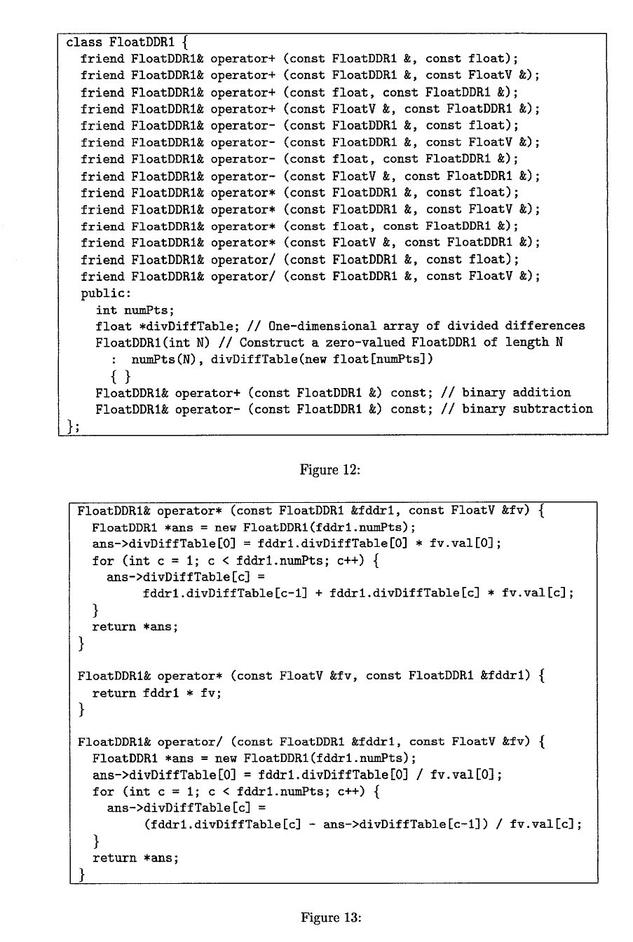

To achieve this, we define class FloatDDR1 as shown in FIG. 12. Compared with class FloatDD, class FloatDDR1 is somewhat impoverished: we can add or subtract two arbitrary FloatDDR1's; however, because we do not have full divided-difference tables available, we cannot multiply two arbitrary FloatDDR1's; nor do we have the full A_{[x}_{₀}_{, . . . ,x}_{ₙ}_{]} matrices that are used at each occurrence of the independent variable. We finesse these difficulties by limiting the other operations of class FloatDDR1 to those defined by the friend functions indicated in the class definition given in FIG. 12: (i) addition, subtraction, and multiplication on either side by a float or a FloatV; (ii) division on the right by a float or a FloatV.

The operations that involve a float argument c have their “obvious” meanings, if one bears in mind that a float value c serves as a stand-in for a full matrix c*I. For the addition (subtraction) operations, c is only added to (subtracted from) the divDiffTable[0] entry of the FloatDDR1 argument. For the multiplication (division) operations, all of the divDiffTable entries are multiplied by (divided by) C.

In the operations that involve a FloatV argument, the FloatV value serves as a stand-in for a full A_{[x}_{₀}_{, . . . ,x}_{ₙ}_{]} matrix. For instance, the operator for multiplication on the right by a FloatV can be thought of as performing a form of matrix multiplication—but specialized to produce only the first row of the output divided-difference table (and to use only values that are available in the given FloatDDR1 and FloatV arguments); see FIG. 13. It might be thought that the operator for multiplication on the left by a FloatV does not have the proper values available in the given FloatV and FloatDDR1 arguments to produce the first row of the product divided-difference table as output. (In particular, the second argument, which is of type FloatDDR1, is a row vector, yet we want to produce a row vector as the result.) However, it is easy to show that divided-difference matrices axe commutative:

F [symbol] *G [symbol] =(F*G) [symbol] =(G*F) [symbol] =G [symbol] *F [symbol] . (16)

Consequently, the operator for multiplication on the left by a FloatV can be treated as if the FloatV were on the right (see FIG. 13).

As with class FloatDD, the division operator is implemented using a form of back substitution—specialized in FIG. 13 to compute just what is needed for the first row of the divided-difference table.

Because only a limited set of arithmetic operations are available for objects of class FloatDDR1, this divided-difference arithmetic can only be applied to procedures that have a certain special syntactic structure, namely ones that are “accumulative” in the independent variable (with only “right-accumulative” quotients). In other words, the procedure must never perform arithmetic operations (other than addition or subtraction) on two local variables that both depend on the independent variable. (This issue is illustrated in Example 13.)

### EXAMPLE 11

The procedure Poly::Eval for evaluating a polynomial via Horner's rule is an example of a procedure of the right form. Consequently, an overloaded version of Poly::Eval that uses FloatDDR1 arithmetic can be written as shown below on the right:

| | | |
|---|---|---|
| // Evaluation via Horner's rule | | // Evaluation via Horner's rule |
| float Poly::Eval(float x) { | | FloatDDR1 Poly::Eval(const FloatV &x) { |
| float ans = 0.0; | | FloatDDR1 ans(x.numPts); // ans = 0.0 |
| for (int i = degree; i >= 0; i−−) { | [symbol] | for (int i = degree; i >= 0; i−−) { |
| ans = ans * x + coeff[i]; | | ans = ans * x + coeff[i]; |
| } | | } |
| return ans; | | return ans; |
| } | | } |

Example 5 discussed the procedure Poly::Eval_{—}1DD, a transformed version of Poly::Eval that computes the value of the first divided difference of a polynomial with respect to two values, x₀ and x₁. With the way that the overloaded operations are defined for class FloatDDR1, when the actual parameter supplied for x is a FloatV of length two consisting of x₀ and x₁, the procedure

FloatDDR1 Poly::Eval(const FloatV &x)

performs essentially the same steps as Poly::Eval_{—}1DD. One slight difference is that, in addition to returning the value of the first divided difference, the FloatDDR1 version also returns the result of evaluating the polynomial on x₀. Another difference is that with class FloatDDR1, because of our trick for handling multiplication by a FloatV on the left (cf. Eqn. (16) and the discussion that follows), FloatDDR1 arithmetic can be used with programs that contain multiplications by the independent variable x on the left as well as on the right. (The transformation used in Example 5 could also be enhanced in this fashion.)

As with the methods that have been presented for computational divided differencing and higher-order computational divided differencing, FloatDDR1 arithmetic can be used to produce values of interest for computational differentiation. For instance, suppose we have transformed procedure F:

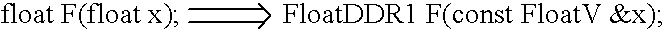

When all of the xᵢ values in the actual parameter supplied for FloatV x are the same value, say \overline{x}, then the FloatDDR1 value returned as the output holds the Taylor coefficients for the expansion of F at \overline{x} (cf. formula (12)). Thus, the FloatV divided-difference arithmetic generalizes previously known techniques for producing accurate Taylor coefficients for functions defined by programs [Ral83, Ral84].

### EXAMPLE 12

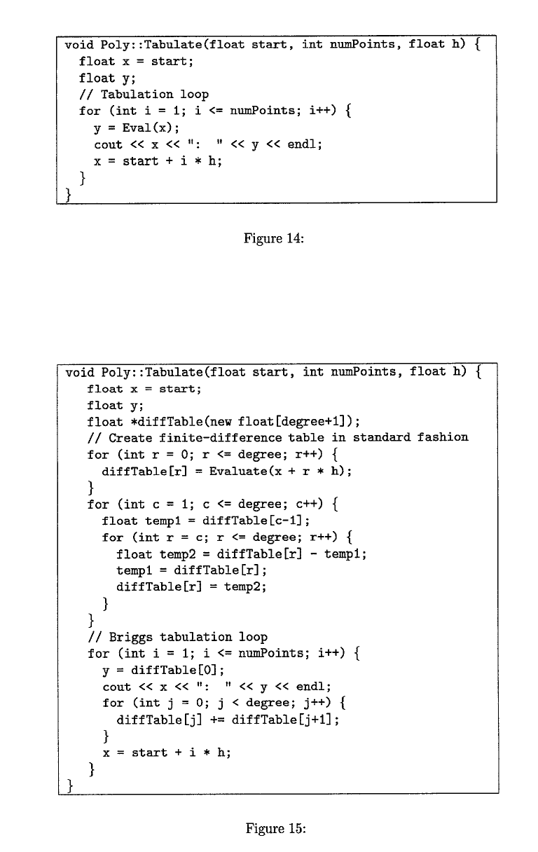

Suppose that you wish to tabulate the value of a polynomial P at a number of evenly spaced points. One approach is merely to evaluate P at each point, as shown in FIG. 14. In that program, Eval is the member function of class Poly that evaluates a polynomial (e.g., via Horner's rule), of type

float Poly::Eval(float x);

An alternative is to use “Briggs's method” ([Gol77] and [PK82, pp. 403-404]), which exploits the fact that it is possible to obtain the value of P(x+h) from P(x) faster than by calculating P(x+h) directly. In this approach, one makes use of the notion of the (forward) finite difference of a function F with respect to h, defined as follows:

ΔₕF(x) [symbol] F(x+h)−F(x). (17)

If P is a degree-N polynomial, one evaluates P at the points start, start+h, . . . , start+(N−1)*h, start+N*h, and then creates an array diffTable[ ] that consists of P (start), together with first, second, . . . , N^{th} finite differences of P with respect to these points [CdB72, pp. 214]. Once diffTable[ ] has been created, it can be used to obtain values for P at an arbitrary number of equally spaced points (starting at start) by iterating over the following block of code:

y = diffTable[0];
cout << x << “: ” << y << endl;
diffTable[0] += diffTable[1];
diffTable[1] += diffTable[2];

.
.
.

diffTable[N−1] += diffTable[N];
x = start + i * h;

The advantage of Briggs's method is that, for a degree-N polynomial, it obtains the value of the polynomial at each successive point using just N additions, whereas direct evaluation via Horner's rule uses N multiplications and N additions for each point.

One way to implement Briggs's method is shown below; in particular, this code creates diffTable[ ] by repeated application of Eqn. (17) (i.e., using a succession of subtraction operations), as shown in FIG. 15. However, this method of generating the initial values in finite-difference table diffTable[ ] on entry to the Briggs tabulation loop involves subtraction operations, and hence may magnify any round-off errors in the N+1 values computed for P; this can lead to very inaccurate results (see below).

An alternative approach to Briggs's method makes use of the divided-difference arithmetic FloatDDR1 to generate a more accurate collection of initial values in finite-difference table diffTable[ ] on entry to the Briggs tabulation loop. This method for initializing diffTable[ ] involves three steps:

Create a FloatV of equally spaced points, starting at start and separated by h, where the number of points is one more than the degree of the polynomial.

Introduce a single call on the member function

FloatDDR1 Poly::Eval(const FloatV &x);

to create the first row of the divided-difference table for the polynomial with respect to the given FloatV.

Convert the resulting FloatDDR1 (which holds divided-difference values) into the first row of a finite-difference table for the polynomial by multiplying each entry by an appropriate adjustment factor (i.e., the i^{th} entry of the finite-difference table, where 0≦i≦N, is i!*hⁱ*P[x₀, x₁, . . . ,xᵢ] [CdB72, Lemma 4.1]).

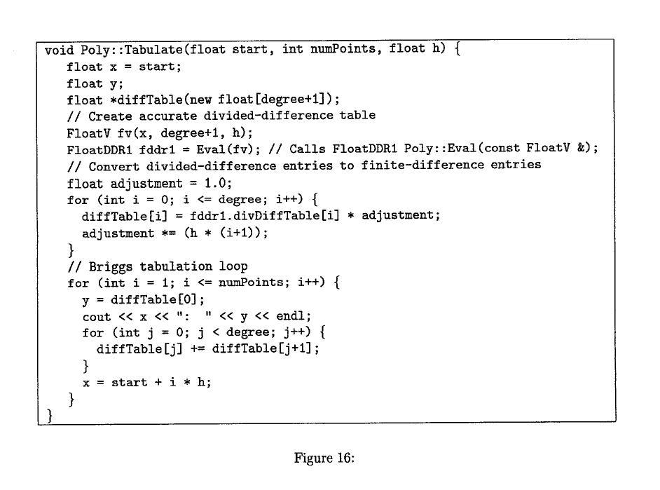

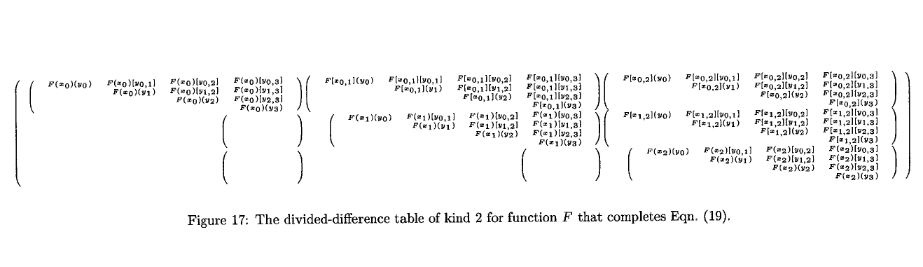

This initialization method is used in the version of Tabulate shown in FIG. 16.

We now present some empirical results that provide a concrete illustration of the benefits gained from using the third variant of Poly::Tabulate. Again, we work with the polynomial P(x)=2.1*x³−1.4*x²−0.6*x+1.1, and perform computations using single-precision floating-point arithmetic on a Sun SPARCstation 20/61 running SunOS 5.6. Programs were compiled with the egcs-2.91.66 version of g++ (egcs-1.1.2 release) with optimization at the −01 level. The following table shows what happens when P(x) is evaluated at the 10,001 points in the interval [0.0, 1.0] with a grid spacing of 0.0001. (Places where the results from the three methods differ are indicated in boldface.)

| | Evaluate | Standard Finite | Computational Div. |
|---|---|---|---|
| | via Horner | Diff. + Briggs | Diff. + Briggs |
| x | P(x) | P(x) | P(x) |
| 0.0000 | 1.10000 | 1.10000 | 1.10000 |
| 0.0001 | 1.09994 | 1.09994 | 1.09994 |
| 0.0002 | 1.09988 | 1.09988 | 1.09988 |
| . | . | . | . |
| . | . | . | . |
| . | . | . | . |
| 0.9998 | 1.19942 | 19844.3 | 1.19941 |
| 0.9999 | 1.19971 | 19850.3 | 1.19970 |
| 1.0000 | 1.20000 | 19856.2 | 1.19999 |
| Time | 7.64 | 5.49 | 5.62 |
| (milliseconds) | | | |

The numbers that appear in the third column for P(0.9998), P(0.9999), and P(1.0000) are not typographical errors. What happens is that round-off errors in the computation of the initial finite-difference table via the standard method—which uses repeated subtractions—causes the table to be initialized to 1.1, −5.99623e−05, −1.19209e−07, and 1.19209e−07. In contrast, the initial values produced via the method based on computational divided differencing are 1.1, −6.0014e−05, −2.79874e−08, and 1.26e−11. After 10,000 iterations of the Briggs tabulation loop, accumulated errors have caused the values in the third column to diverge widely from the correct ones.

Overall, the method based on computational divided differencing is far more accurate than the one in which diffTable[ ] is obtained by repeated subtraction operations (and only 2% slower). Furthermore, the values obtained from the method based on computational divided differencing are nearly as accurate as those obtained by reevaluating the polynomial at each point, but the reevaluation method is 36% slower.

If we attempt to use FloatDDR1 arithmetic in a procedure that is not “accumulative” in the independent variable, with only “right-accumulative” quotients, the overload-resolution mechanism of the C++ compiler will detect and report a problem. This is illustrated by the following example:

### EXAMPLE 13

Returning to the future-value calculation of Example 10, because the desired quantity in Eqn. (14) is merely a first divided difference, we might attempt to carry out the computation by means of FloatDDR1 arithmetic—hoping to save the cost of computing and storing the (1, 1) entry of the divided-difference table—using the following overloaded version of procedure power:

FloatDDR1 power(FloatV &x, unsigned int n) {

unsigned int mask = 1 << (num_bits − 1);
FloatDDR1 ans(CONST, 2, 1.0); // ans = 1.0
for (unsigned int i = 0; i < num_bits; i++) {

ans = ans * ans; // overload-resolution fails here
if (mask & n) ans = ans * x;
mask >>= 1;

}
return ans;

}

However, at the statement

ans=ans*ans;

procedure power multiplies two local variables that both depend on the independent variable x. Consequently, the FloatDDR1 version of power is not accumulative in the independent variable. In the case of the Microsoft Visual C++ compiler, the following error message is issued:

binary ‘*’: no operator defined which takes a left-hand operand of type ‘class FloatDDR1’

Multi-Dimensional Computational Divided Differencing

In this section, we explain how to define a third divided-differencing arithmetic that extends our techniques to handle multi-dimensional computational divided differencing (i.e., computational divided differencing of functions of several variables). As background material for the presentation of this idea, let us start by reiterating a few points concerning the divided-difference tables that result from computational divided differencing of functions of a single variable. In the following discussion, we assume that the divided-difference table in question has been constructed with respect to some known collection of values x₀, x₁, . . . ,xₙ.

As mentioned in the discussion of Eqn. (15), a divided-difference table can be thought of as a (redundant) representation of an interpolating polynomial. For instance, if you have a divided-difference table T (and know the appropriate vector of values x₀, x₁, . . . , xₙ, as well), you can explicitly construct the interpolating polynomial in Newton form by using the values in the first row of T in accordance with Eqn. (15). One of the consequences of this point is so central to what follows that it is worthwhile to state it explicitly and to introduce some helpful notation:

Observation 14 [Representation Principle]. A divided-difference table T is a finite representation of a function Func[T] defined by Eqn. (15). (Note that if F=Func[T], then T=F [symbol] .)

Given two divided-difference tables, T₁ and T₂, that are defined with respect to the same set of points x₀, x₁, . . . , xₙ, the operations of matrix addition, subtraction, multiplication, and division applied to T₁ and T₂ yield representations of the sum, difference, product and quotient, respectively, of Func[T₁] and Func[T₂].

In other words, the operations of class FloatDD provide ways to (i) instantiate representations of functions of one variable (by evaluating programs in which floats have been replaced by FloatDDs), and (ii) perform operations on function representations (i.e., by addition, multiplication, etc. of FloatDD values).

It is also worthwhile restating the Computational Divided-Differencing Principle (Observation 8), adding the additional remark given in the second paragraph:

Observation 15 [Computational Divided-Differencing Principle Redux]. Rather than computing a divided-difference table with respect to the points x₀, x₁, . . . , xₙ by invoking the program n+1 times and then applying Eqns. (7) and (8), we may instead evaluate the program (once) using a divided-difference arithmetic that overloads arithmetic operations as matrix operations, substituting A_{[x}_{₀}_{, . . . ,x}_{ₙ}_{]} for each occurrence of the formal parameter x, and c*I for each occurrence of a constant c.

Furthermore, this principle can be applied to divided-difference tables for functions on any field (because addition, subtraction, multiplication, and division operations are required, together with additive and multiplicative identity elements).

We now consider the problem of defining an appropriate notion of divided differencing for a function F of several variables. Observation 14 provides some guidance, as it suggests that the generalized divided-difference table for F that we are trying to create should also be thought of as a representation of a function of several variables that interpolates F. Such a generalized computational divided-differencing technique will be based on the combination of Observations 14 and 15.

Because we have already used the term higher-order to refer generically to second, third, . . . , n^{th} divided differences, we use the term higher-kind to refer to the generalized divided-difference tables that arise with functions of several variables. In the remainder of this section, we make use of an alternative notation for the divided-difference operator • [symbol] ^{[x}^{₀}^{, . . . ,x}^{ₙ}^{]}:

$${DD}_{[ {x}_{0} , … , {x}_{n} ]}^{1} ⟦ F ⟧ {=}^{def} {F}^{} .$$

We use DD¹[F] when the xᵢ are understood, and abbreviate ranges of variables in the usual way, e.g.,

$${DD}_{[ {x}_{0 , 3} ]}^{1} ⟦ F ⟧ = {DD}_{[ {x}_{0} , {x}_{1} , {x}_{2} , {x}_{3} ]}^{1} ⟦ F ⟧ = {F}^{ [ {x}_{0} , {x}_{1} , {x}_{2} , {x}_{3} ]} .$$

The notation DD¹[•] refers to divided-difference tables of kind 1 (the kind we are already familiar with from the discussion of higher-order computational divided differencing, namely FloatDD values). Below, we use DD²[•] to refer to divided-difference tables of kind 2; in general, we use DD^{k}[•] to refer to divided-difference tables of kind k.

To understand the basic principle that underlies our approach, consider the problem of creating a surface that interpolates a two-variable function F(x, y) with respect to a grid formed by three coordinate values x₀, x₁, x₂ in the x-dimension, and four coordinate values y₀, y₁, y₂, y₃ in the y-dimension. The clearest way to explain the technique in common programming-language terminology involves currying F. That is, instead of working with F: float×float→float, we work with F: float→float→float. We can create (a representation of) an interpolating surface for F (i.e., a divided-difference table of kind 2, denoted by

$${DD}_{[ {x}_{0 , 2} ] , [ {y}_{0 , 3} ]}^{2} ⟦ F ⟧ )$$

by building a divided-difference table of kind 1 using the functions F(x₀), F(x₁), and F(x₂), each of which is of type float→float, as the “interpolation points”.

Note that this process requires that we be capable of performing addition, subtraction, multiplication, and division of functions. However, each of the functions F(x₀), F(x₁), and F(x₂) is itself a one-argument function for which we can create a representation, namely by building the divided-difference tables

$${DD}_{[ {y}_{0 , 3} ]}^{1} ⟦ F ( {x}_{0} ) ⟧ , {DD}_{[ {y}_{0 , 3} ]}^{1} ⟦ F ( {x}_{1} ) ⟧ , and {DD}_{[ {y}_{0 , 3} ]}^{1} ⟦ F ( {x}_{2} ) ⟧$$

(with respect to the coordinate values y₀, y₁, y₂, and y₃). By Observation 15, the arithmetic operations on functions F(x₀), F(x₁), and F(x₂) needed to create

$${DD}_{[ {x}_{0 , 2} ] , [ {y}_{0 , 3} ]}^{2} ⟦ F ⟧$$

can be carried out by performing matrix operations on the matrices

$${DD}_{[ {y}_{0 , 3} ]}^{1} ⟦ F ( {x}_{0} ) ⟧ , {DD}_{[ {y}_{0 , 3} ]}^{1} ⟦ F ( {x}_{1} ) ⟧ , and {DD}_{[ {y}_{0 , 3} ]}^{1} ⟦ F ( {x}_{2} ) ⟧ .$$

For instance,

$$\begin{matrix}{DD}_{[ {y}_{0 , 3} ]}^{1} ⟦ F [ {x}_{0} , {x}_{1} ] ⟧ = {DD}_{[ {y}_{0 , 3} ]}^{1} ⟦ \frac{F ( {x}_{0} ) - F ( {x}_{1} )}{{x}_{0} - {x}_{1}} ⟧ \\ = \frac{{DD}_{[ {y}_{0 , 3} ]}^{1} ⟦ F ( {x}_{0} ) ⟧ - {DD}_{[ {y}_{0 , 3} ]}^{1} ⟦ F ( {x}_{1} ) ⟧}{{x}_{0} - {x}_{1}} .\end{matrix} \qquad ( 18 )$$

In what follows, it is convenient to express functions using lambda notation (i.e., in λz.exp, z is the name of the formal parameter, and exp is the function body). For instance, λx.λy.x denotes the curried two-argument function (of type float→float→float) that merely returns its first argument. For our purposes, the advantage of lambda notation is that it provides a way to express the anonymous one-argument function that is returned when a curried two-argument function is supplied a value for its first argument (e.g., (λx.λy.x)(x₀) returns λy.x₀).

In short, the idea is that a divided-difference table of kind 2 for function F is a matrix of matrices:

$$\begin{matrix}{DD}_{[ {x}_{0 , 2} ] , [ {y}_{0 , 3} ]}^{2} ⟦ F ⟧ = {DD}_{[ {x}_{0 , 2} ]}^{1} ⟦ λ x . {DD}_{[ {y}_{0 , 3} ]}^{1} ⟦ F ( x ) ⟧ ⟧ \\ = ( \begin{matrix}{DD}_{[ {y}_{0 , 3} ]}^{1} ⟦ F ( {x}_{0} ) ⟧ & {DD}_{[ {y}_{0 , 3} ]}^{1} ⟦ F [ {x}_{0} , {x}_{1} ] ⟧ & {DD}_{[ {y}_{0 , 3} ]}^{1} ⟦ F [ {x}_{0} , {x}_{1} , {x}_{2} ] ⟧ \\ & {DD}_{[ {y}_{0 , 3} ]}^{1} ⟦ F ( {x}_{1} ) ⟧ & {DD}_{[ {y}_{0 , 3} ]}^{1} ⟦ F [ {x}_{1} , {x}_{2} ] ⟧ \\ & & {DD}_{[ {y}_{0 , 3} ]}^{1} ⟦ F ( {x}_{2} ) ⟧\end{matrix} ) \\ = the matrix shown in Fig . 17\end{matrix} \qquad ( 19 )$$

It is instructive to consider some concrete instances of

$${DD}_{[ {x}_{0 , 2} ] , [ {y}_{0 , 3} ]}^{2} ⟦ F ⟧$$

for various F's:

### EXAMPLE 16

Consider the function λx.λy.x. For 0≦i≦2, we have

$${DD}_{[ {y}_{0 , 3} ]}^{1} ⟦ ( λ x . λ y . x ) ( {x}_{i} ) ⟧ = {DD}_{[ {y}_{0 , 3} ]}^{1} ⟦ λ y . {x}_{i} ⟧ = ( \begin{matrix}{x}_{i} & 0 & 0 & 0 \\ & {x}_{i} & 0 & 0 \\ & & {x}_{i} & 0 \\ & & & {x}_{i}\end{matrix} )$$

and, for 0≦i≦1, we have

$$\begin{matrix}{DD}_{[ {y}_{0 , 3} ]}^{1} ⟦ ( λ x . λ y . x ) [ {x}_{i} , {x}_{i + 1} ] ⟧ = {DD}_{[ {y}_{0 , 3} ]}^{1} ⟦ \frac{( λ x . λ y . x ) ( {x}_{i} ) - ( λ x . λ y . x ) ( {x}_{i + 1} )}{{x}_{i} - {x}_{i + 1}} ⟧ \\ = {DD}_{[ {y}_{0 , 3} ]}^{1} ⟦ \frac{λ y . {x}_{i} - λ y . {x}_{i + 1}}{{x}_{i} - {x}_{i + 1}} ⟧ \\ = {DD}_{[ {y}_{0 , 3} ]}^{1} ⟦ λ y .1 ⟧ \\ = ( \begin{matrix}1 & 0 & 0 & 0 \\ & 1 & 0 & 0 \\ & & 1 & 0 \\ & & & 1\end{matrix} )\end{matrix}$$

Consequently, we have

$${DD}_{[ {x}_{0 , 2} ] , [ {y}_{0 , 3} ]}^{2} ⟦ λ x . λ y . x ⟧ = ( \begin{matrix}( \begin{matrix}{x}_{0} & 0 & 0 & 0 \\ & {x}_{0} & 0 & 0 \\ & & {x}_{0} & 0 \\ & & & {x}_{0}\end{matrix} ) & ( \begin{matrix}1 & 0 & 0 & 0 \\ & 1 & 0 & 0 \\ & & 1 & 0 \\ & & & 1\end{matrix} ) & ( \begin{matrix}0 & 0 & 0 & 0 \\ & 0 & 0 & 0 \\ & & 0 & 0 \\ & & & 0\end{matrix} ) \\ ( \begin{matrix} & & & \\ & & & \\ & & & \\ & & & \end{matrix} ) & ( \begin{matrix}{x}_{1} & 0 & 0 & 0 \\ & {x}_{1} & 0 & 0 \\ & & {x}_{1} & 0 \\ & & & {x}_{1}\end{matrix} ) & ( \begin{matrix}1 & 0 & 0 & 0 \\ & 1 & 0 & 0 \\ & & 1 & 0 \\ & & & 1\end{matrix} ) \\ ( \begin{matrix} & & & \\ & & & \\ & & & \\ & & & \end{matrix} ) & ( \begin{matrix} & & & \\ & & & \\ & & & \\ & & & \end{matrix} ) & ( \begin{matrix}{x}_{2} & 0 & 0 & 0 \\ & {x}_{2} & 0 & 0 \\ & & {x}_{2} & 0 \\ & & & {x}_{2}\end{matrix} )\end{matrix} ) \qquad ( 20 )$$

### EXAMPLE 17

Consider the function λx.λy.y. For 0≦i≦2, we have

$${DD}_{[ {y}_{0 , 3} ]}^{1} ⟦ ( λ x . λ y . y ) ( {x}_{i} ) ⟧ = {DD}_{[ {y}_{0 , 3} ]}^{1} ⟦ λ y . y ⟧ = ( \begin{matrix}{y}_{0} & 1 & 0 & 0 \\ & {y}_{1} & 1 & 0 \\ & & {y}_{2} & 1 \\ & & & {y}_{3}\end{matrix} )$$

and, for 0≦i≦1, we have

$$\begin{matrix}{DD}_{[ {y}_{0 , 3} ]}^{1} ⟦ ( λ x . λ y . y ) [ {x}_{i} , {x}_{i + 1} ] ⟧ = {DD}_{[ {y}_{0 , 3} ]}^{1} ⟦ \frac{( λ x . λ y . y ) ( {x}_{i} ) - ( λ x . λ y . y ) ( {x}_{i + 1} )}{{x}_{i} - {x}_{i + 1}} ⟧ \\ = {DD}_{[ {y}_{0 , 3} ]}^{1} ⟦ \frac{λ y . y - λ y . y}{{x}_{i} - {x}_{i + 1}} ⟧ \\ = {DD}_{[ {y}_{0 , 3} ]}^{1} ⟦ λ y .0 ⟧ \\ = ( \begin{matrix}0 & 0 & 0 & 0 \\ & 0 & 0 & 0 \\ & & 0 & 0 \\ & & & 0\end{matrix} )\end{matrix}$$

Consequently, we have

$${DD}_{[ {x}_{0 , 2} ] , [ {y}_{0 , 3} ]}^{2} ⟦ λ x . λ y . y ⟧ = ( \begin{matrix}( \begin{matrix}{y}_{0} & 1 & 0 & 0 \\ & {y}_{1} & 1 & 0 \\ & & {y}_{2} & 1 \\ & & & {y}_{3}\end{matrix} ) & ( \begin{matrix}0 & 0 & 0 & 0 \\ & 0 & 0 & 0 \\ & & 0 & 0 \\ & & & 0\end{matrix} ) & ( \begin{matrix}0 & 0 & 0 & 0 \\ & 0 & 0 & 0 \\ & & 0 & 0 \\ & & & 0\end{matrix} ) \\ ( \begin{matrix} & & & \\ & & & \\ & & & \\ & & & \end{matrix} ) & ( \begin{matrix}{y}_{0} & 1 & 0 & 0 \\ & {y}_{1} & 1 & 0 \\ & & {y}_{2} & 1 \\ & & & {y}_{3}\end{matrix} ) & ( \begin{matrix}0 & 0 & 0 & 0 \\ & 0 & 0 & 0 \\ & & 0 & 0 \\ & & & 0\end{matrix} ) \\ ( \begin{matrix} & & & \\ & & & \\ & & & \\ & & & \end{matrix} ) & ( \begin{matrix} & & & \\ & & & \\ & & & \\ & & & \end{matrix} ) & ( \begin{matrix}{y}_{0} & 1 & 0 & 0 \\ & {y}_{1} & 1 & 0 \\ & & {y}_{2} & 1 \\ & & & {y}_{3}\end{matrix} )\end{matrix} ) \qquad ( 21 )$$

Moreover, Observation 15 tells us that divided-difference tables for functions of two variables can be built up by means of a divided-difference arithmetic that operates on matrices of matrices. That is, we can build up divided-difference tables of kind 2 for more complex functions of x and y by using operations on matrices of matrices, substituting DD²[λx.λy.x] for each occurrence of the formal parameter x in the function, and DD²[λx.λy.y] for each occurrence of the formal parameter y.

### EXAMPLE 18

For the function λx.λy.(x×y), DD²[λx.λy.(x×Y)] can be created by multiplying the matrices DD²[λx.λy.x] and DD²[λx.λy.y] from Eqns. (20) and (21), respectively:

$$\begin{matrix}{DD}^{2} ⟦ λ x . λ y \cdot ( x \times y ) ⟧ = {DD}^{2} ⟦ ( λ x . λ y . x ) \times ( λ x . λ y . y ) ⟧ \\ = {DD}^{2} ⟦ λ x . λ y . x ⟧ \times {DD}^{2} ⟦ λ x . λ y . y ⟧ \\ = ( \begin{matrix}( \begin{matrix}{x}_{0} {y}_{0} & {x}_{0} & 0 & 0 \\ & {x}_{0} {y}_{1} & {x}_{0} & 0 \\ & & {x}_{0} {y}_{2} & {x}_{0} \\ & & & {x}_{0} {y}_{3}\end{matrix} ) & ( \begin{matrix}{y}_{0} & 1 & 0 & 0 \\ & {y}_{1} & 1 & 0 \\ & & {y}_{2} & 1 \\ & & & {y}_{3}\end{matrix} ) & ( \begin{matrix}0 & 0 & 0 & 0 \\ & 0 & 0 & 0 \\ & & 0 & 0 \\ & & & 0\end{matrix} ) \\ ( \begin{matrix} & & & \\ & & & \\ & & & \\ & & & \end{matrix} ) & ( \begin{matrix}{x}_{1} {y}_{0} & {x}_{1} & 0 & 0 \\ & {x}_{1} {y}_{1} & {x}_{1} & 0 \\ & & {x}_{1} {y}_{2} & {x}_{1} \\ & & & {x}_{1} {y}_{3}\end{matrix} ) & ( \begin{matrix}{y}_{0} & 1 & 0 & 0 \\ & {y}_{1} & 1 & 0 \\ & & {y}_{2} & 1 \\ & & & {y}_{3}\end{matrix} ) \\ ( \begin{matrix} & & & \\ & & & \\ & & & \\ & & & \end{matrix} ) & ( \begin{matrix} & & & \\ & & & \\ & & & \\ & & & \end{matrix} ) & ( \begin{matrix}{x}_{2} {y}_{0} & {x}_{2} & 0 & 0 \\ & {x}_{2} {y}_{1} & {x}_{2} & 0 \\ & & {x}_{2} {y}_{2} & {x}_{0} \\ & & & {x}_{2} {y}_{3}\end{matrix} )\end{matrix} )\end{matrix}$$

$$\begin{matrix}Note , for example , that the ( 0 , 1 ) entry in the above matrix , namely \\ ( \begin{matrix}{y}_{0} & 1 & 0 & 0 \\ & {y}_{1} & 1 & 0 \\ & & {y}_{2} & 1 \\ & & & {y}_{3}\end{matrix} )\end{matrix}$$

was obtained via the calculation

$$\begin{matrix}( \begin{matrix}{x}_{0} & 0 & 0 & 0 \\ & {x}_{0} & 0 & 0 \\ & & {x}_{0} & 0 \\ & & & {x}_{0}\end{matrix} ) \times ( \begin{matrix}0 & 0 & 0 & 0 \\ & 0 & 0 & 0 \\ & & 0 & 0 \\ & & & 0\end{matrix} ) + \\ ( \begin{matrix}1 & 0 & 0 & 0 \\ & 1 & 0 & 0 \\ & & 1 & 0 \\ & & & 1\end{matrix} ) \times ( \begin{matrix}{y}_{0} & 1 & 0 & 0 \\ & {y}_{1} & 1 & 0 \\ & & {y}_{2} & 1 \\ & & & {y}_{3}\end{matrix} ) + \\ ( \begin{matrix}0 & 0 & 0 & 0 \\ & 0 & 0 & 0 \\ & & 0 & 0 \\ & & & 0\end{matrix} ) \times ( \begin{matrix}0 & 0 & 0 & 0 \\ & 0 & 0 & 0 \\ & & 0 & 0 \\ & & & 0\end{matrix} )\end{matrix} \qquad ( 22 )$$

and not by the use of Eqn. (18), which involves a matrix subtraction, a scalar subtraction, and a scalar division:

$$\begin{matrix}{DD}_{[ {y}_{0 , 3} ]}^{1} [ ( λ x \cdot λ y \cdot ( x \times y ) ) [ {x}_{0} , {x}_{1} ] ] = \frac{{DD}_{[ {y}_{0 , 3} ]}^{1} [ λ y \cdot ( {x}_{0} \times y ) ] - {DD}_{[ {y}_{0 , 3} ]}^{1} [ λ y \cdot ( {x}_{1} \times y ) ]}{{x}_{0} - {x}_{1}} \\ = \frac{ ( \begin{matrix}{x}_{0} {y}_{0} & {x}_{0} & 0 & 0 \\ & {x}_{0} {y}_{1} & {x}_{0} & 0 \\ & & {x}_{0} {y}_{2} & {x}_{0} \\ & & & {x}_{0} {y}_{3}\end{matrix} ) - ( \begin{matrix}{x}_{1} {y}_{0} & {x}_{1} & 0 & 0 \\ & {x}_{1} {y}_{1} & {x}_{1} & 0 \\ & & {x}_{1} {y}_{2} & {x}_{1} \\ & & & {x}_{1} {y}_{3}\end{matrix} )}{{x}_{0} - {x}_{1} }\end{matrix} \qquad ( 23 )$$

Expressions (22) and (23) are equivalent over real numbers, but not over floating-point numbers. By sidestepping the explicit subtraction and division operations in expression (23), expression (22) avoids the potentially disastrous magnification of round-off error that can occur with floating-point arithmetic.

The principle illustrated in Example 18 gives us the machinery that we need to perform computational divided differencing for bivariate functions defined by programs. As usual, computational divided differencing is performed by changing the types of formal parameters, local variables, and return values to the type of an appropriate divided-difference arithmetic.

Furthermore, these ideas can be applied to a function F with an arbitrary number of variables: when F has k variables, DD^{k}[F], F's divided-difference table of kind k, is a matrix of matrices of . . . of matrices nested to depth k. Currying with respect to the first parameter of F “peels off” one dimension; DD^{k}[F] is a matrix whose entries are divided-difference tables of kind k−1 (i.e., matrices of matrices of . . . of matrices nested to depth k−1). For instance, the diagonal entries are the divided-difference tables of kind k−1 for the (k−1)-parameter functions F(x₀), F(x₁), . . . , F(xₙ) (i.e., DD^{k-1}[F(x₀)], DD^{k-1}[F(x₁)], . . . , DD^{k-1}[F(xₙ)]).

To implement this approach in C++, we define two classes and one class template:

Class template template <int k> class DDArith can be instantiated with a value k>0 to represent divided-difference tables of kind k. Each object of class DDArith<k> has links to sub-objects of class DDArith<k−1>.

Class DDArith<0> represents the base case; DDArith<0> objects simply hold a single float.

Class IntVector, a vector of int's, is used to describe the number of points in each dimension of the grid of coordinate points.

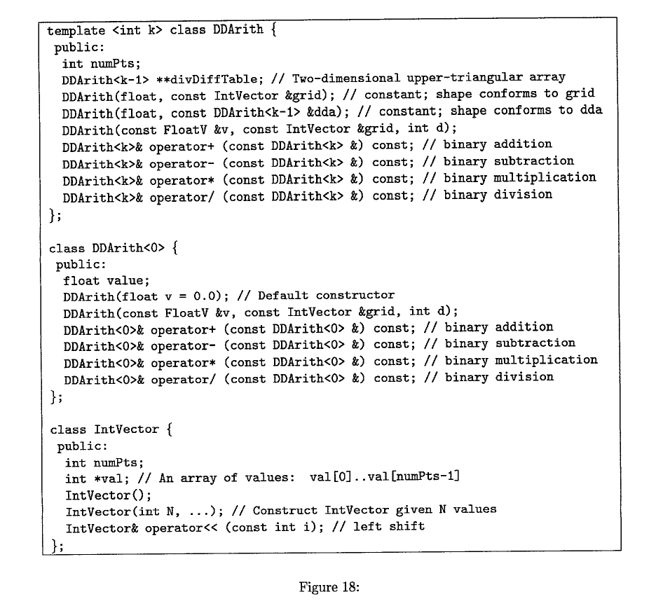

Excerpts from the definitions of these classes are shown in FIG. 18.

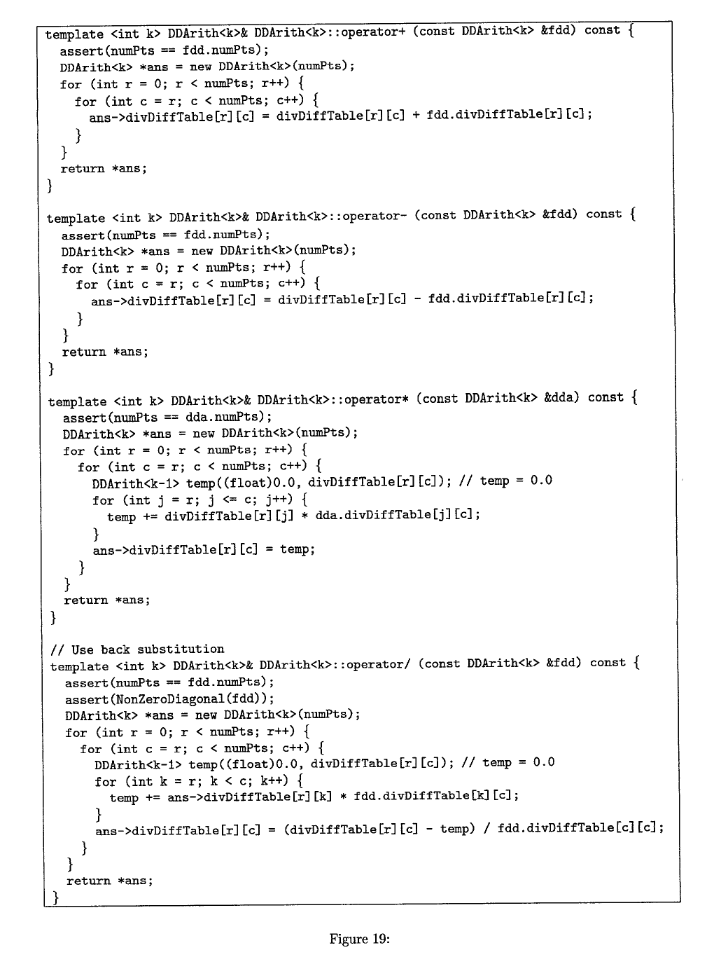

The operations of class DDArith<k> are overloaded in a fashion similar to those of class FloatDD. (Class FloatDD is essentially identical to DDArith<1>.) For instance, the overloaded multiplication operator performs matrix multiplication, etc. (See FIG. 19.)

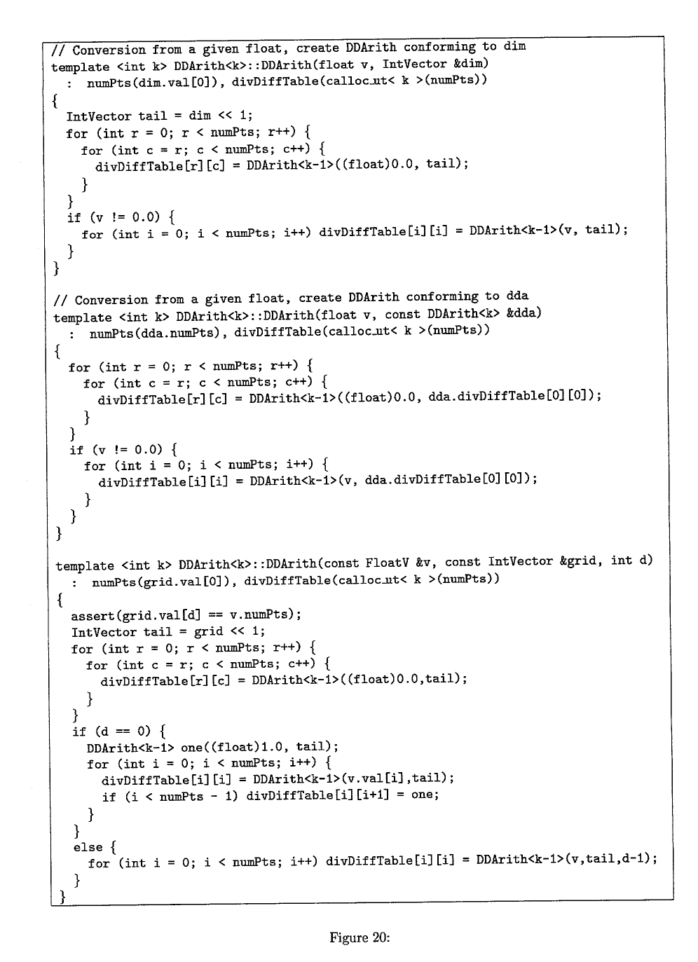

Class DDArith<k> has two constructors for creating a DDArith<k> object from a float constant. They differ only in their second arguments (an IntVector versus a DDArith<k>), which are used to determine the appropriate dimensions to use at each level in the nesting of matrices. (See FIG. 20.)

Class DDArith<k> has an additional constructor for creating a DDArith<k> value for the independent variable associated with a given argument position of the function on which computational divided differencing is to be carried out. For instance, suppose that variable z is the independent variable associated with argument position d+1 in the procedure on which computational divided differencing is to be carried out. To generate an appropriate DDArith<k>object for z for a given set of grid values z₀, . . . , zₘ, a FloatV with the values z₀, . . . , zₘ is created, and then passed to the DDArith<k> constructor

template <int k> DDArith<k>::DDArith(const FloatV &v, const IntVector &grid, int d);

(See FIG. 20.)

### EXAMPLE 19

The following code fragment generates two DDArith<2> values, x and y, which correspond to the matrices shown in Eqns. (20) and (21), respectively:

IntVector grid(2,3,4); // descriptor for a 2-dimensional grid of size 3-by-4
FloatV fv_x(3,x₀,x₁,x₂);
DDArith<2> x(fv_x,grid,0); // argument position 1
FloatV fv_y(4,y₀,y₁,y₂,y₃);
DDArith<2> y(fv_y,grid,1); // argument position 2

### EXAMPLE 20

Consider a C++ class BivariatePoly that represents bivariate polynomials, and a member function BivariatePoly::Eval that evaluates a polynomial via a bivariate version of Horner's rule:

class BivariatePoly {
public:

float Eval(float,float);

private:

int degree1,degree2;
// Array coeff [0..degree1][0..degree2]
float **coeff;

```
  };
  // Evaluation via bivariate Horner's rule
```

```
  float BivariatePoly::Eval(float x,float y) {
  float ans = 0.0;
  for (int i = degree1; i >= 0; i−−) {
    float temp = 0.0;
    for (int j = degree2; j >= 0; j−−) {
      temp = temp * y + coeff [i][j];
    }
    ans = ans * x + temp;
  }
  return ans;
```

}

Similar to what has been done in Examples 5, 6, 9, and 11, computational divided differencing is carried out on this version of Eval by changing the types of its formal parameters, local variables, and return value from float to DDArith<2>:

```
// Evaluation via bivariate Horner's rule
DDArith<2> BivariatePoly::Eval(const DDArith<2> &x,
const DDArith<2> &y) {
  DDArith<2>ans(0.0,x); // ans = 0.0
  for (int i = degree1; i >= 0; i−−) {
    DDArith<2> temp(0.0,y); // temp = 0.0
    for (int j = degree2; j >= 0; j−−) {
      temp = temp * y + coeff[i][j];
    }
    ans = ans * x + temp;
  }
  return ans;
}
```

To use this procedure to create a divided-difference table of kind 2 for a given variable P of type BivariatePoly*, with respect to the 3-by-4 grid {x₀,x₁,x₂}×{y₀,y₁,y₂,y₃}, we would generate the IntVector grid and DDArith<2> values x and y as shown in Example 19, and then invoke

P—>Eval(x,y);

In general, if there are k independent variables (i.e., k dimensions), and vᵢ is the number of sample coordinate values for the i^{th} dimension, where 1≦i≦k, each value of type DDArith<k> will use space

$${\prod }_{i = 1}^{k} \frac{{v}_{2} ( {v}_{i} + 1 )}{2} .$$

Compared with the time required for the original program, the slow-down factor for the DDArith<k> version is bounded by

$$O ( {\prod }_{i = 1}^{k} {v}_{i}^{3} ) .$$

One final point concerning costs: by generalizing the grid descriptors slightly, it is possible to devise an even more general divided-differencing arithmetic that is heterogeneous in shape with respect to different argument positions. By “heterogeneous”, we mean that full two-dimensional (upper-triangular) divided-difference tables could be provided for some argument positions, while other argument positions could just provide a single row of divided differences (i.e., one-dimensional, FloatDDR1-like tables). By this means, when a procedure body is “accumulative” in certain of its formal parameters but not others, it would be possible to tailor the divided-differencing version of the procedure to improve its efficiency. (In the case of procedure

DDArith<2> BivariatePoly::Eval,

it would be possible to specify that both argument positions provide FloatDDR1-like tables.)

Relationship to Prior Art

This section concerns prior art, which falls into three categories:

Computational Differentiation

Computational differentiation is a well-established area of numerical analysis, with its own substantial literature [Wen64, Ral81, GC92, BBCG96, Gri00]. The importance of the subject is underscored by the fact that the 1995 Wilkinson Prize for outstanding contributions to the field of numerical software was awarded to Chris Bischof (then at Argonne) and Alan Carle (Rice) for the development of the FORTRAN computational-differentiation system ADIFOR 2 [BCKM96]. As discussed in the section titled “Computational Divided Differencing as a Generalization of Computational Differentiation”, computational divided differencing is a generalization of computational differentiation: a program resulting from computational divided differencing can be used to obtain derivatives (as well as divided differences), whereas a program resulting from computational differentiation can only produce derivatives (and not divided differences).

Other Work on Accurate Divided Differencing

The program-transformation techniques for creating accurate divided differences that are the basis for the present invention are based on a 1964 result of Opitz's [Opi64] about the mathematical properties of higher-order divided differences (i.e., column two of FIG. 7), which was later rediscovered in 1980 by McCurdy [McC80]. However, Opitz and McCurdy both discuss how to create accurate divided differences only for expressions. In this invention, the idea has been applied to the creation of accurate divided differences for functions defined by programs.

McCurdy, and later Kahan and Fateman [KF85] and Rall and Reps [RR01], looked at ways to compute accurate divided differences for library functions (i.e., sin, cos, exp, etc.).

Kahan and Fateman also investigated how similar techniques can be used to avoid unsatisfactory numerical answers when evaluating formulas returned by symbolic-algebra systems. In particular, their work was motivated by the observation that naive evaluation of a definite integral ∫ₐ^{b} f(x)dx can sometimes produce meaningless answers: When a symbolic-algebra system produces a closed-form solution for the indefinite integral ∫ f(x)dx, say G(x), the result of the computation G(b)−G(a) may have no significant digits. Kahan and Fateman show that divided differences can be used to develop accurate numerical formulas that sidestep this problem.

One of the techniques developed by McCurdy for computing accurate divided-difference tables involved first computing just the first row of the table and then generating the rest of the entries by a backfilling algorithm. He studied the conditions under which this technique maintained sufficient accuracy. However, his algorithm for accurately computing the first row of the divided-difference table was based on a series expansion of the function, rather than a divided-difference arithmetic, such as the FloatDDR1 arithmetic.

Divided-difference arithmetic for first divided differences has also been called slope arithmetic, and an interval version of it has been investigated previously as a way to obtain an interval enclosure for the range of a function evaluated over an interval [KN85, ZW90, Rat96]. It has been shown that interval slope arithmetic can yield tighter enclosures than methods based on derivatives [KN85, ZW90, Rat96]. Zuhe and Wolfe have also shown that a form of interval divided-difference arithmetic involving second divided differences can provide even tighter interval enclosures [ZW90]. The present invention is based on point (non-interval) divided-difference arithmetics, but makes use of a divided-difference arithmetic for divided differences of arbitrary order. It also uses a generalized divided-difference arithmetic that applies in the case of multi-variate functions involving a fixed, but arbitrary, number of variables-as well as various specializations of it, which improve run-time efficiency in certain situations.

Other Work on Controlling Round-Off Error in Numerical Computations

Computational differentiation and computational divided differencing are methods for controlling round-off error that can arise in two types of numerical computations. Other work aimed at controlling round-off error in numerical computations includes interval-arithmetic methods for verifying the accuracy of computed results, which have been developed for many basic numerical computations [HHKR93, HHKR95], as well as the work on remainder differential algebra, which can be viewed as a way of extending higher-order computational differentiation so that the resulting program also computes an interval remainder term [MB96].

While the foregoing specification of the invention has described it with reference to specific embodiments thereof, it will be apparent that various modifications and changes may be made thereto without departing from the broader spirit and scope of the invention. The specification and drawings are, accordingly, to be regarded in an illustrative rather than a restrictive sense.

What is claimed is:

1 A method carried out by a computer for transforming a univariate function f defined by a program f, into a new program f_DD, comprising the following steps:
a. The independent variable and all variables of the program that depend on the independent variable are transformed to have a multiplicity of fields in accordance with the class declarations and construction operations of classes FloatDD and FloatV of FIGS. 8 and 9.
b. Operations on the independent variable and all variables of the program that depend on the independent variable are transformed to manipulate their multiplicity of fields in accordance with the operator declarations of FIG. 10.

2 A method carried out by a computer for transforming a univariate function f, defined by a program f that is “accumulative” in the independent variable (with only “right-accumulative” quotients), into a new program f_DDR1, comprising the following steps:
a. The independent variable and all variables of the program that depend on the independent variable are transformed to have a multiplicity of fields in accordance with the class declarations and construction operations of class FloatDDR1 of FIG. 12.
b. Operations on the independent variable and all variables of the program that depend on the independent variable are transformed to manipulate their multiplicity of fields in accordance with the operator declarations of FIG. 13.

3 A method carried out by a computer for transforming a multivariate function f defined by a program f, into a new program f_DDArith, comprising the following steps:
a. The independent variables and all variables of the program that depend on the independent variables are transformed to have a multiplicity of fields in accordance with the class declarations and construction operations of class template DDArith<k> and classes DDArith<0> and IntVector of FIGS. 18 and 20.
b. Operations on the independent variables and all variables of the program that depend on the independent variables are transformed to manipulate their multiplicity of fields in accordance with the operator declarations of FIG. 19.

4 A method carried out by a computer for evaluating the k^{th} derivative of a function f, defined by a program f, at the point x₀, comprising the following steps:
a. Transforming f into program f_DD by the method of claim 1.
b. Evaluating f_DD with respect to a vector of length at least k+1, made up of the values x₀, x₀, . . . , x₀.
c. Selecting any element of the k^{th} off-diagonal of the resulting matrix of values, and multiplying by k!.

5 A method carried out by a computer for evaluating the k^{th} derivative of a function f, defined by a program f that is “accumulative” in the independent variable (with only “right-accumulative” quotients), at the point x₀, comprising the following steps:
a. Transforming f into program f_DDR1 by the method of claim 2.
b. Evaluating f_DDR1 with respect to a vector of length at least k+1, made up of the values x₀, x₀, . . . , x₀.
c. Selecting entry k (counting from 0) from the resulting vector of values, and multiplying by k!.

6 A method carried out by a computer for creating a representation of the Newton form of the interpolating polynomial for function f, defined by a program f, with respect to the points x₀, x₁, . . . , xₙ, comprising the following steps:
a. Transforming f into program f_DD by the method of claim 1.
b. Evaluating f_DD with respect to the vector of values x₀, x₁, . . . , xₙ.
c. Selecting the first row of the resulting matrix of values, and creating a vector of values to represent the Newton form of the interpolating polynomial.

7 A method carried out by a computer for creating a representation of the Newton form of the interpolating polynomial for function f, defined by a program f that is “accumulative” in the independent variable (with only “right-accumulative” quotients), with respect to the points x₀, x₁, . . . , xₙ, comprising the following steps:
a. Transforming f into program f_DR1 by the method of claim 2.
b. Evaluating f_DDR1 with respect to the vector of values x₀, x₁, . . . , xₙ.
c. Using the resulting vector of values to represent the Newton form of the interpolating polynomial.

8 A method carried out by a computer for plotting a function f (or generating a grid representation of f) at a number of evenly spaced points defined by starting value x₀ and separation h, where f is defined by a program f, comprising the following steps:
a. Transforming f into program f_DD by the method of claim 1.
b. Evaluating f_DD with respect to the vector of values x₀, x₀+h, . . . , x₀+N*h.
c. Selecting the first row of the resulting matrix of values, and converting it into the first row of a finite-difference table for the interpolating polynomial for f by multiplying the i^{th} entry, for 0≦i≦N, by i!*hⁱ.
d. Generating the desired number of points by applying Briggs's method.

9 A method carried out by a computer for plotting a function f (or generating a grid representation of f) at a number of evenly spaced points defined by starting value x₀ and separation h, where f is defined by a program f that is “accumulative” in the independent variable (with only “right-accumulative” quotients), comprising the following steps:
a. Transforming f into program f_DDR1 by the method of claim 2.
b. Evaluating f_DDR1 with respect to the vector of values x₀, x₀+h, . . . , x₀+N*h.
c. Converting the resulting vector of values into the first row of a finite-difference table for the interpolating polynomial for f by multiplying the i^{th} entry, for 0≦i≦N, by i!*hⁱ.
d. Generating the desired number of points by applying Briggs's method.
